(19) United States
(12) Patent Application Publication
(10) Pub. No.: US 2017/0325466 A1
(43) Pub. Date: Nov. 16, 2017

(54) DOUBLE COUPLER NOZZLE FOR PIPING BAGS AND STANDS THEREFOR

(71) Applicant: Jan Folkmar, Weggis (CH)

(72) Inventor: Jan Folkmar, Weggis (CH)

(21) Appl. No.: 15/528,251

(22) PCT Filed: Mar. 25, 2015
(86) PCT No.: PCT/IB2015/001450

§ 371 Date: May 19, 2017

Related U.S. Application Data
(60) Provisional application No. 62/082,818, filed on Nov. 21, 2014.

(51) Int. Cl. A21C 15/00; A23G 3/28; B65D 35/38

(52) U.S. Cl. CPC A21C 15/005; A23G 3/28; B65D 35/38

(57) ABSTRACT

A double coupler nozzle system for sealing to a pair of flexible film bags (or to a double bag, i.e. three (3) triangles of film welded down the diagonals or a single piping bag which has been welded down the length) having a wider upper end and a conical lower end with an opening for flowable material inside the bag and for expressing the flowable material. The system comprises a pair of hollow nozzle bases each having an exterior wall and an interior wall and being coupled together along the interior walls.

### BACKGROUND OF THE INVENTION

This invention relates to nozzles such as may be used to form devices commonly referred to as piping bags, pastry bags or icing bags, and to stands used to hold such bags during filling. Such bags are generally filled with a thick, flowable material such as icing, pureed fruit or vegetable, or mayonnaise, which is expressed from the bag through a nozzle, usually to achieve a decorative effect.

### SUMMARY OF THE INVENTION

Bearing in mind the problems and deficiencies of the prior art, it is therefore an object of the present invention to provide improved nozzles, piping bags and piping bag stands that provide for easy, efficient, and versatile dispensing of flowable materials there-from.

It is another object of the present invention to provide improved and easy to use double coupler nozzles, triple coupler nozzles, and/or quadruple coupler nozzles for dispensing combinations of flowable materials there-from.

Still other objects and advantages of the invention will in part be obvious and will in part be apparent from the specification.

The above and other objects, which will be apparent to those skilled in the art, are achieved in the present invention which is directed to a double coupler nozzle system for sealing to a pair of flexible film bags (or to a double bag, i.e. three (3) triangles of film welded down the diagonals or a single piping bag which has been welded down the length) having a wider upper end and a conical lower end with an opening for flowable material inside the bag and for expressing the flowable material. The system comprises a pair of hollow nozzle bases each having an exterior wall and an interior wall and being coupled together along the interior walls. The exterior wall of each nozzle base form a portion of a substantially right circular truncated cone with a larger diameter end and a smaller diameter end and cut along a plane containing the longitudinal axis of the cone, the interior wall of each nozzle base being non-planar and spanning edges of the exterior wall to form an inlet opening adjacent the nozzle base larger diameter end and an outlet opening adjacent the nozzle base smaller diameter end, the nozzle base interior walls extending inward or outward (or male/female) and complimenting each other when the bases are coupled together along the interior walls. Each of the nozzle bases are adapted to be received snugly within the conical lower end of one of the bags with the film of the lower end of the bag extending over the exterior and interior walls of the nozzle bases and having a lower bag edge ending intermediate the larger and smaller diameter ends of the nozzle base, and having film of the bags between the respective interior walls of the coupled nozzle bases. The coupled nozzle bases permit side-by-side simultaneous flow of material from bags sealed to the nozzle bases and out of the outlets of the coupled nozzle bases. The double coupler nozzle system may include a retaining ring secured around the exterior walls of the coupled nozzle bases adjacent the larger diameter ends of the nozzle bases, the retaining ring preventing separation of the coupled nozzle bases and sealing the lower ends of flexible bags extending over the exterior and interior walls of the nozzle bases. The double coupler nozzle system may include a tab extending from one of the nozzle base interior walls and contacting the other of the nozzle bases to prevent relative movement of the nozzle bases in a direction along the longitudinal axis. The complimenting inward or outward (or male/female) extension of the nozzle base interior walls when the bases are coupled together may be sufficient to prevent relative movement of the nozzle bases in a direction perpendicular to the longitudinal axis. The double coupler nozzle system may include a tubular outlet at the smaller diameter end of one of the nozzle bases, the tubular outlet permitting outflow of a first material from a bag sealed to the one of the nozzle bases while a second material flows from a bag sealed to the other of the nozzle bases around the first material. The double coupler nozzle system may include a nozzle tip extending over the smaller diameter ends of the coupled nozzle bases, the nozzle tip sealing around the film of the lower ends of the bags around the exterior walls of the coupled nozzle bases and having an outlet opening to permit side-by-side simultaneous flow of material from the bags.

Another aspect of the present invention is direction to a triple coupler nozzle system for sealing to three flexible film bags (or to a combination of a single and double bag) having a wider upper end and a conical lower end with an opening for flowable material inside the bag and for expressing the flowable material. The system comprises three hollow nozzle bases each having an exterior wall and an interior wall and being coupled together along the interior walls, the exterior wall of each nozzle base forming a portion of a substantially right circular truncated cone with a larger diameter end and a smaller diameter end and cut along a plane containing the longitudinal axis of the cone, the interior wall of each nozzle base being non-planar with an included 120 degree angle and spanning edges of the exterior wall to form an inlet opening adjacent the nozzle base larger diameter end and an outlet opening adjacent the nozzle base smaller diameter end, the nozzle base interior walls extending inward or outward (or male/female) and complimenting each other when the bases are coupled together along the interior walls. Each of the nozzle bases are adapted to be received snugly within the conical lower end of one of the bags with the film of the lower end of the bag extending over the exterior and interior walls of the nozzle bases and having a lower bag edge ending intermediate the larger and smaller diameter ends of the nozzle base, and having film of the bags between the respective interior walls of the coupled nozzle bases. The coupled nozzle bases permit side-by-side simultaneous flow of material from bags sealed to the nozzle bases and out of the outlets of the coupled nozzle bases.

Another aspect of the present invention is direction to a quadruple coupler nozzle system for sealing to four flexible film bags (or to a or combination of a single and/or double bag) having a wider upper end and a conical lower end with an opening for flowable material inside the bag and for expressing the flowable material. The system comprises four hollow nozzle bases each having an exterior wall and an interior wall and being coupled together along the interior walls, the exterior wall of each nozzle base forming a portion of a substantially right circular truncated cone with a larger diameter end and .a smaller diameter end and cut along a plane containing the longitudinal axis of the cone, the interior wall of each nozzle base being non-planar with an included 90 degree angle and spanning edges of the exterior wall to form an inlet opening adjacent the nozzle base larger diameter end and an outlet opening adjacent the nozzle base smaller diameter end. The nozzle base interior walls extend inward or outward (or male/female) and complimenting each other when the bases are coupled together along the interior walls. Each of the nozzle bases are adapted to be received snugly within the conical lower end of one of the bags with the film of the lower end of the bag extending over the exterior and interior walls of the nozzle bases and having a lower bag edge ending intermediate the larger and smaller diameter ends of the nozzle base, and having film of the bags between the respective interior walls of the coupled nozzle bases. The coupled nozzle bases permit side-by-side simultaneous flow of material from bags sealed to the nozzle bases and out of the outlets of the coupled nozzle bases.

Another aspect of the present invention is directed to a stand for supporting and filling with flowable material one or more flexible bags having a wider upper end and a conical lower end, the lower end optionally connected to a nozzle for expressing the flowable material, the stand comprising a housing with a substantially conical interior having a larger diameter at an upper end thereof and a smaller diameter at a lower end thereof, the housing having a plurality of slots extending downward from a rim at the upper end along a portion of the length of the housing to form a plurality of wings and capable of receiving folded-down portions of the bag upper end and hold the upper end open for filling flowable material into the bag while suspending the lower end of the bag adjacent the lower end of the housing. The stand may be capable of supporting at least two flexible bags simultaneously with at least one wing receiving folded-down portions of the upper end of one bag and at least one other wing receiving folded-down portions of the upper end of another bag to hold the upper bag ends open for filling flowable material into the at least two bags while suspending lower ends of the bags adjacent the lower end of the housing. The slots may have a curved lower end to permit the upper end of the bag to be removed from over the wings, twisted and re-inserted into a slot curved lower end to hold the upper end of the bag closed. The slots may have an enlarged lower end to permit the upper end of the bag to be removed from over the wings, twisted and re-inserted into a slot enlarged lower end to hold the upper end of the bag closed. The housing may comprise a plurality of frusto-conical sections, each section having a larger diameter at an upper end thereof and a smaller diameter at a lower end thereof, the diameter at a lower end of one section conforming to the diameter of the upper end of another section connected below the one section. Each housing section may have a plurality of slots extending downward from a rim at the upper end along a portion of the length of the housing to form a plurality of said wings. The housing sections may be connectable by threads at upper and lower ends thereof. The housing sections may be separated and nested within each other for transport or storage. The stand may act as a hopper or funnel for flowable material wherein the housing has an opening at the lower end thereof, the housing being capable of receiving flowable material and passing the flowable material out through the lower end opening.

Another aspect of the present invention is directed to a portable stand for supporting and filling with flowable material one or more flexible bags having a wider upper end and a conical lower end, the lower end optionally connected to a nozzle for expressing the flowable material, the stand comprising two first and second half frame portions assembled in secured, adjoining relation to form a shaped upper rim and a shaped lower rim, with each half frame portion having first and second ribs extending between rim portions forming the shaped upper and lower rims when assembled, the lower rim supporting the stand from a surface and the upper rim supporting the bags near the upper ends thereof, the first ribs of the first and second half frame portions being connected along a central portion of their length, each of the first ribs having an offset portion between the central portion and the upper rim portions to form a circumferential gap between the respective upper rim portions capable of receiving folded-down portions of the bag upper end and hold the upper end open for filling flowable material into the bag while suspending the lower end of the bag adjacent the lower end of the stand. The second ribs of the first and second half frame portions may also be connected along a central portion of their length, each of the second ribs having an offset portion between the central portion and the upper rim portions to form a circumferential gap between the respective upper rim portions capable of receiving folded-down portions of the bag upper end and hold the upper end open for filling flowable material into the bag while suspending the lower end of the bag adjacent the lower end of the stand. The stand may act as a stand for filling non-conical flexible bags, such as freezer bags.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view of one or more embodiments of double coupler nozzles in accordance with the invention.

FIGS. 2-3 are different sectional views of FIG. 1 showing one or more embodiments of a disassembled double coupler nozzle of the invention.

FIG. 4 is a perspective view of the double coupler nozzles shown in FIG. 1.

FIG. 5 is a side view of the double coupler nozzles shown in FIG. 1.

FIG. 6 is another perspective view of the double coupler nozzles shown in FIG. 1.

FIGS. 7-9 are different views of other double coupler nozzles in accordance with the various embodiments of the invention.

FIGS. 10-11 are views of various embodiments of the double coupler nozzles of the invention.

FIG. 12 illustrates a double coupler nozzle of the invention in use providing different color decorative icing onto a pastry.

FIG. 13a depicts a prior art double nozzle shown on the left as compared to an embodiment of the double coupler nozzle of the present invention shown on the right.

FIG. 13b depicts a prior art double nozzle shown on the left as compared to an embodiment of the double coupler nozzle of the present invention shown on the right.

FIGS. 14-27 illustrate various views of one or more embodiments of conical double piping bag stands in accordance with the various aspects of the present invention.

FIGS. 28-36 illustrate different views of various embodiments of portable stands for use with pairs of piping bags in accordance with the invention.

FIGS. 37-38 illustrate one or more embodiments of triple coupler nozzles in accordance with the various aspects of the present invention.

FIGS. 39-40 illustrate one or more embodiments of quadruple coupler nozzles in accordance with the various aspects of the present invention.

FIGS. 41-42 illustrate various embodiments of quadruple nozzle base sections of the quadruple coupler nozzles of FIGS. 39-40.

### DESCRIPTION OF THE PREFERRED EMBODIMENT(S)

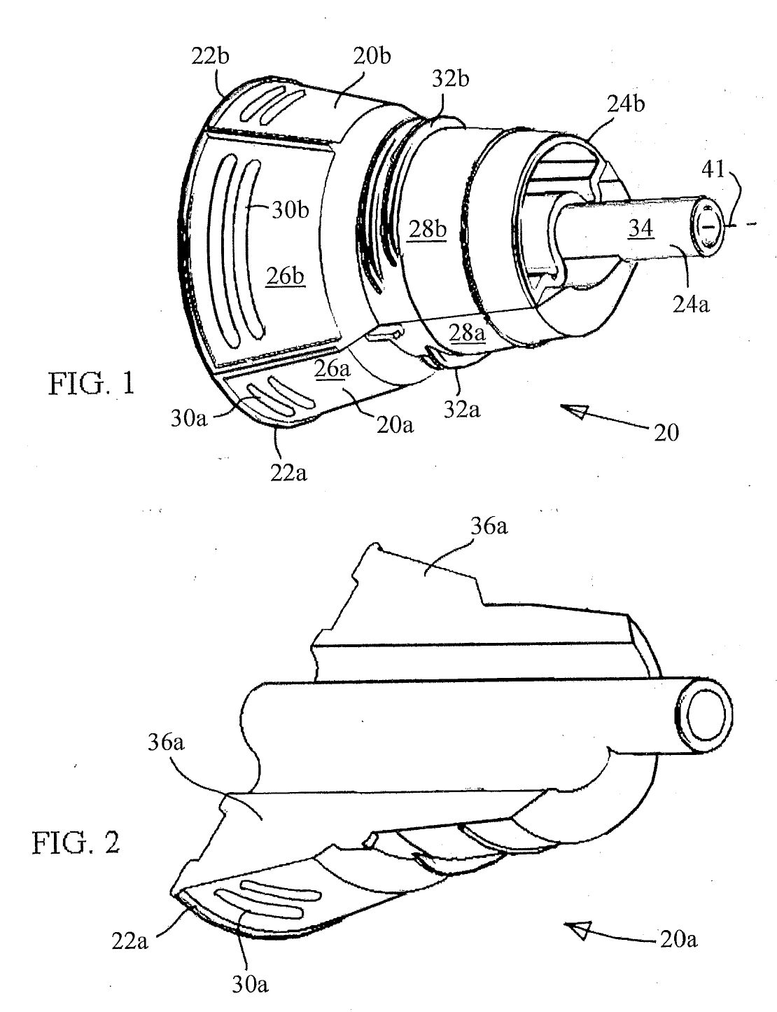

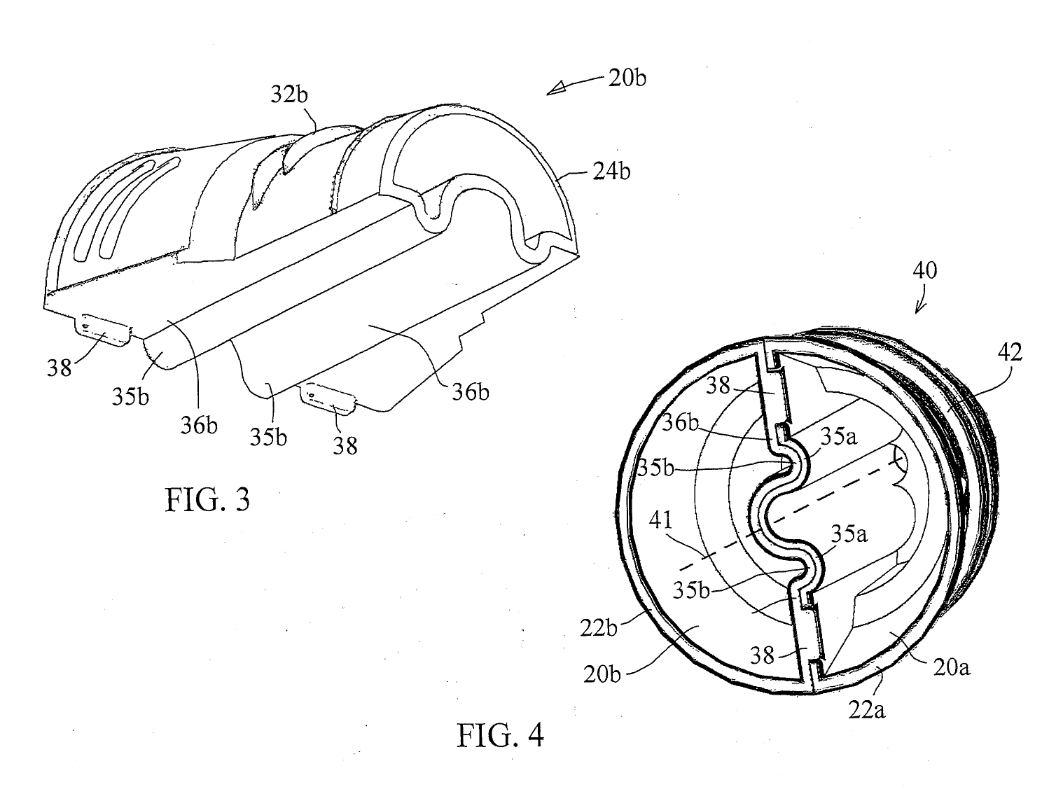

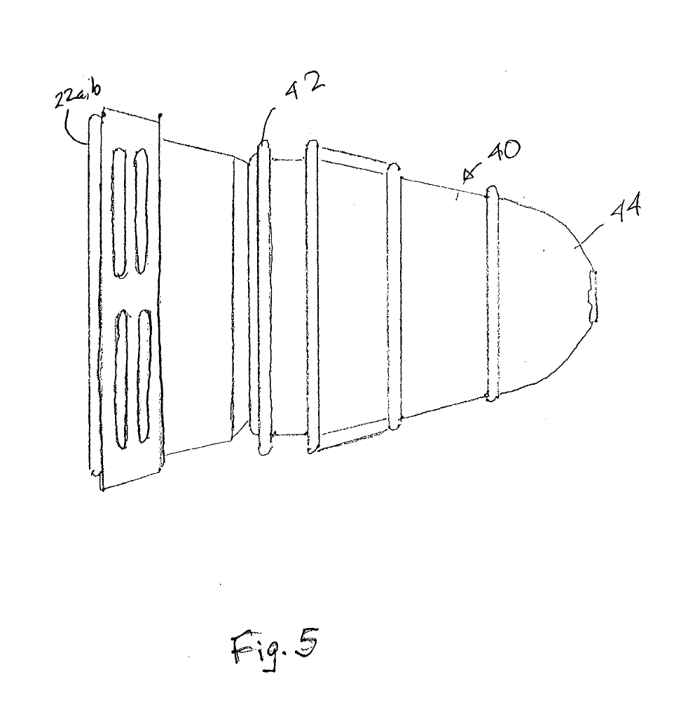

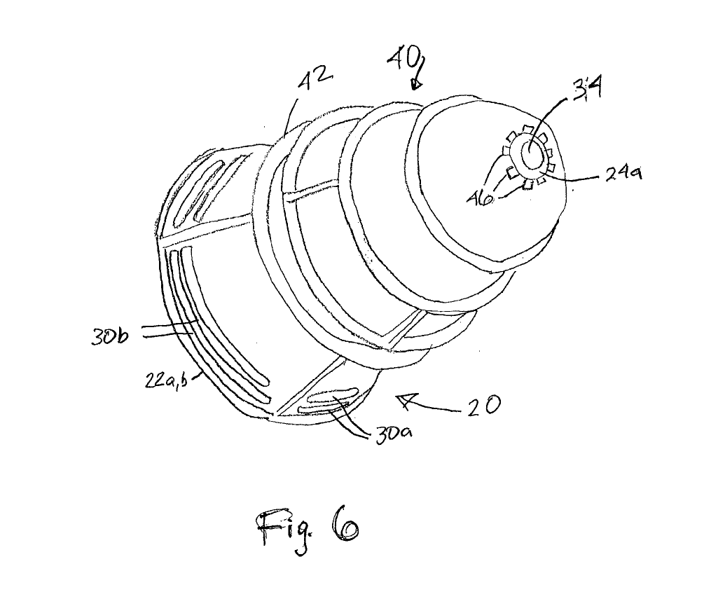

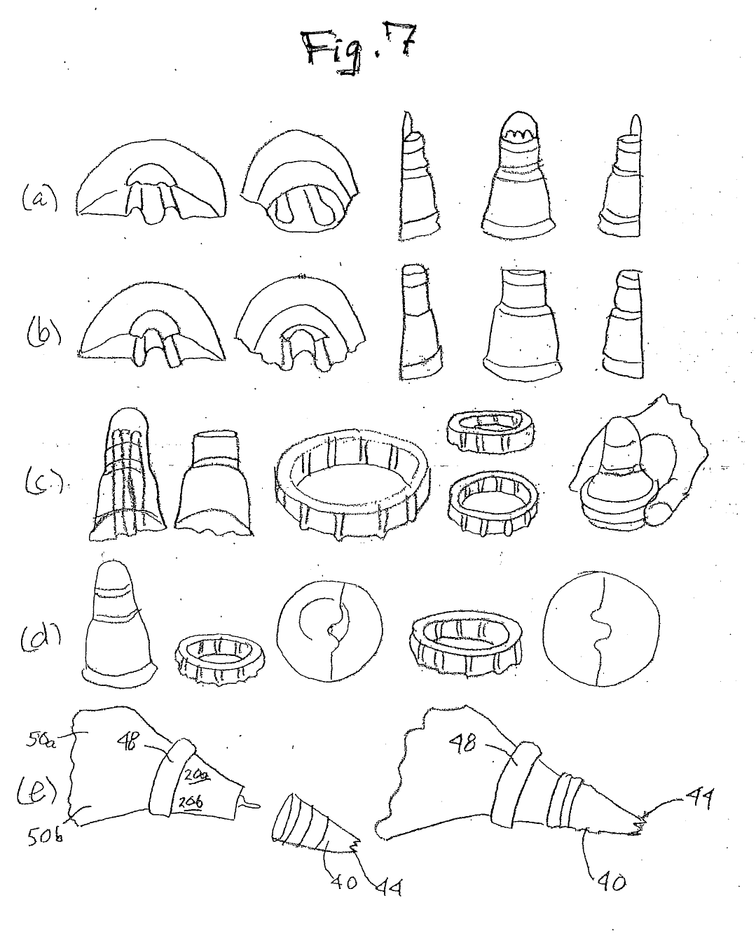

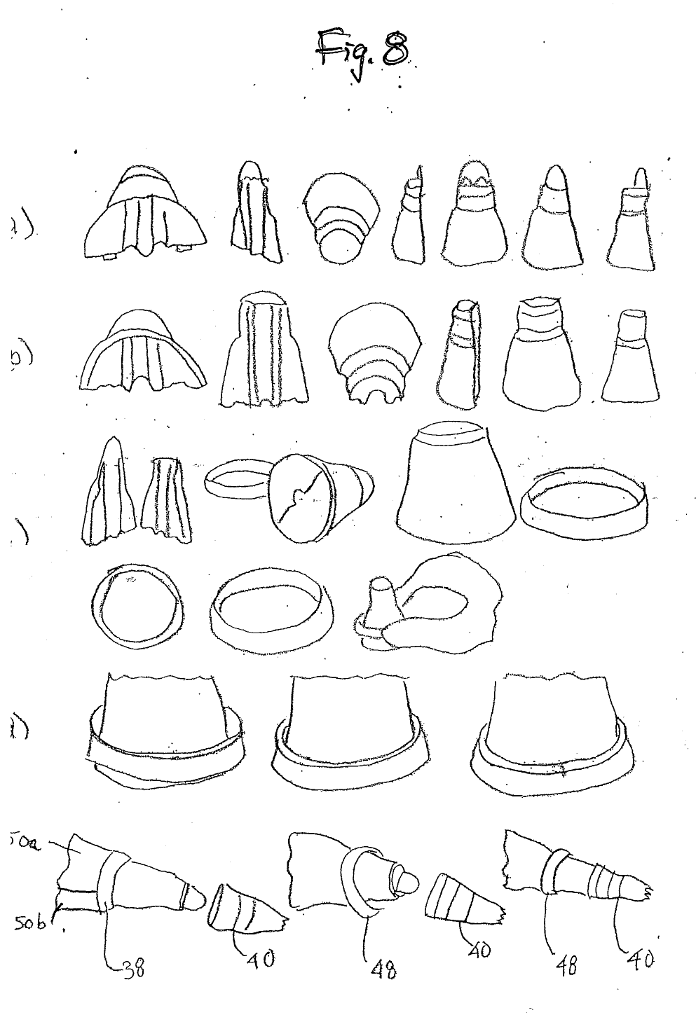

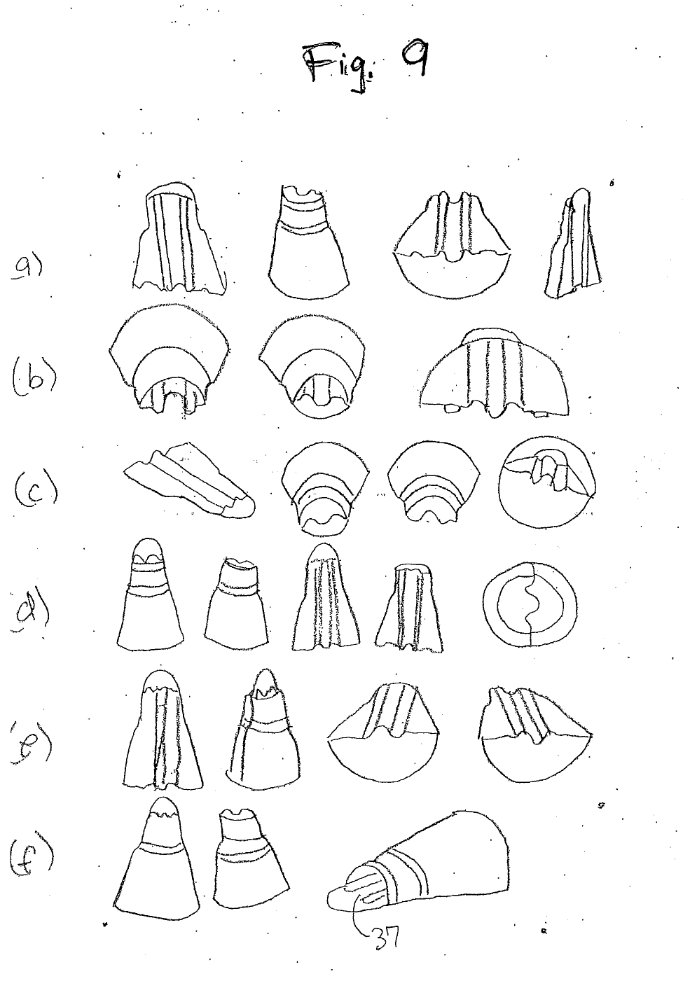

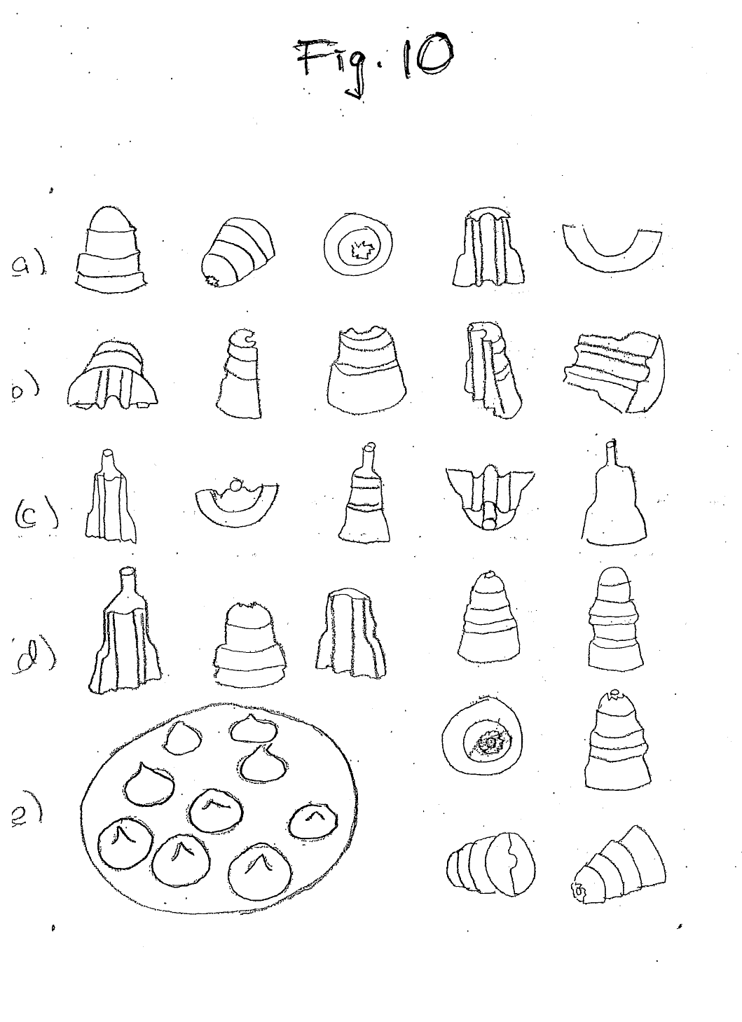

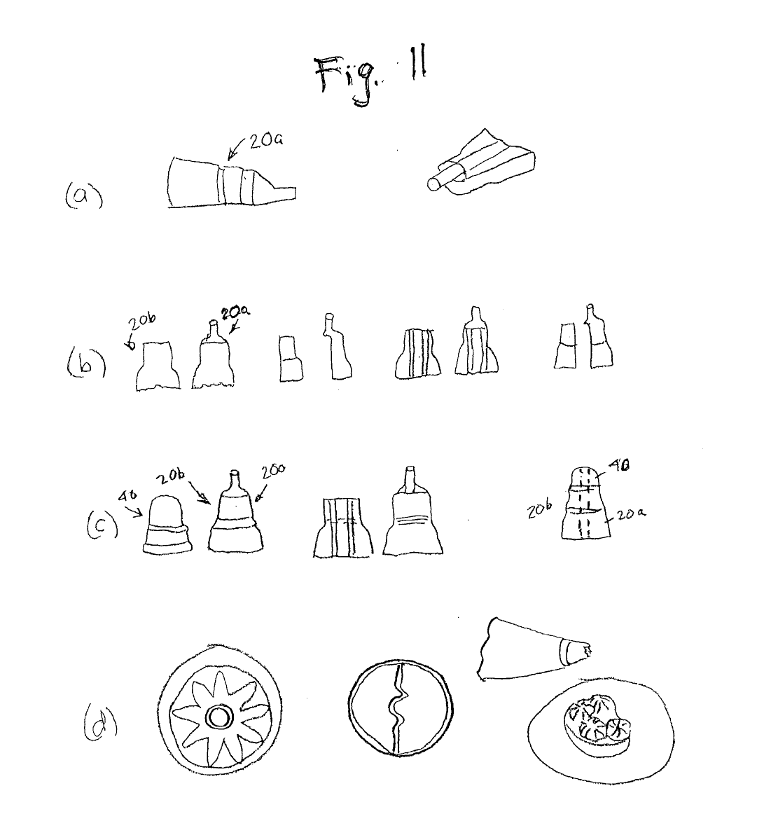

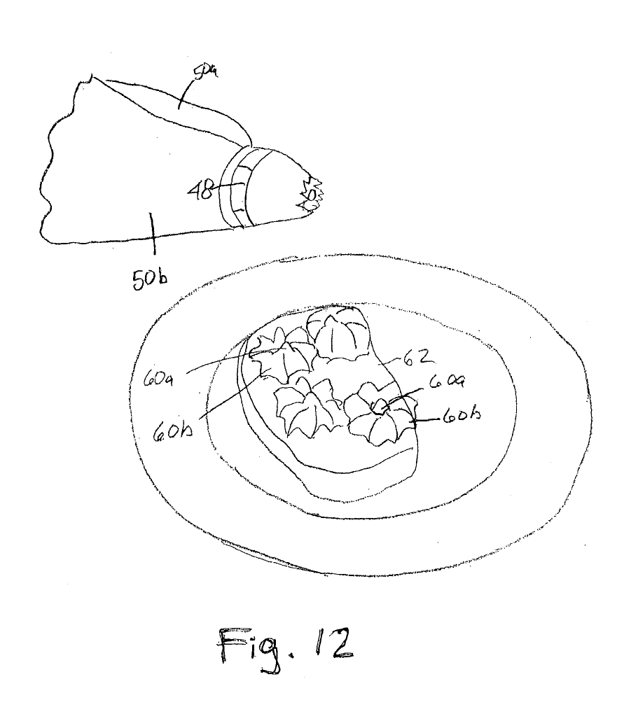

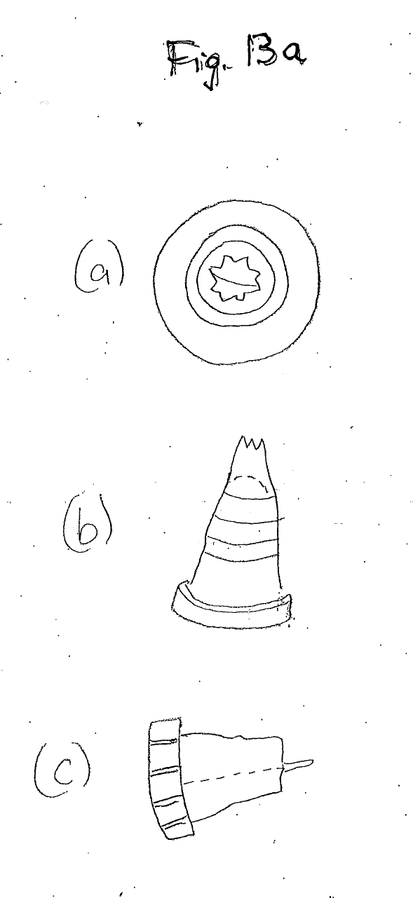

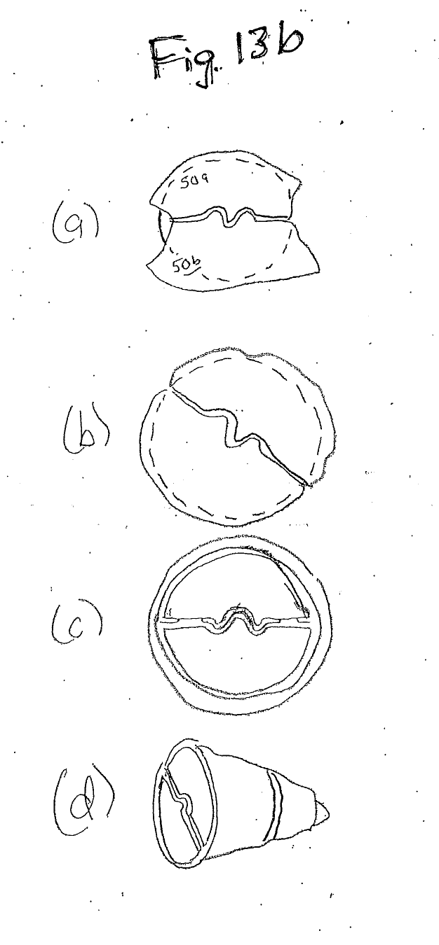

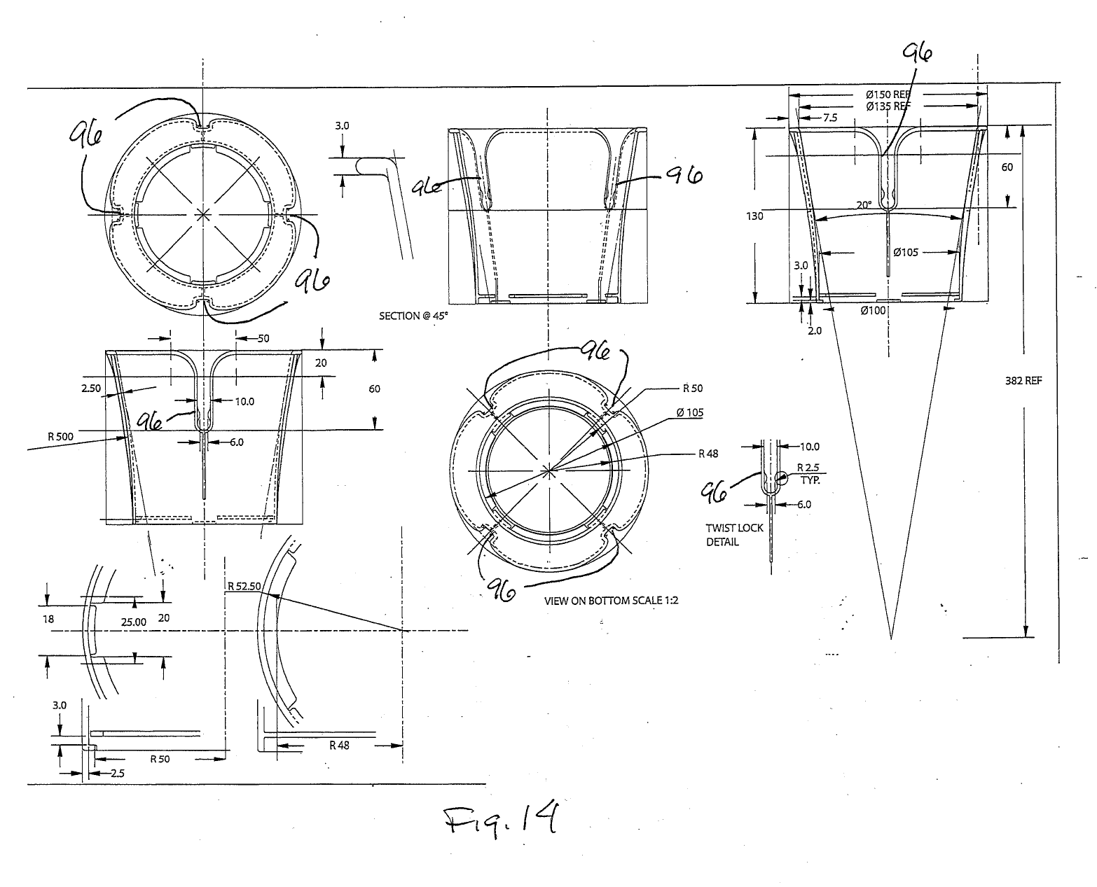

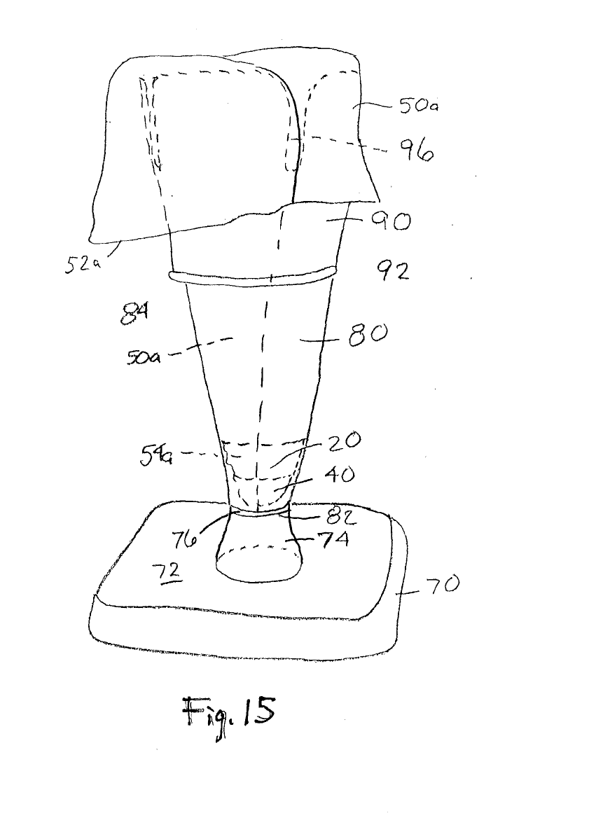

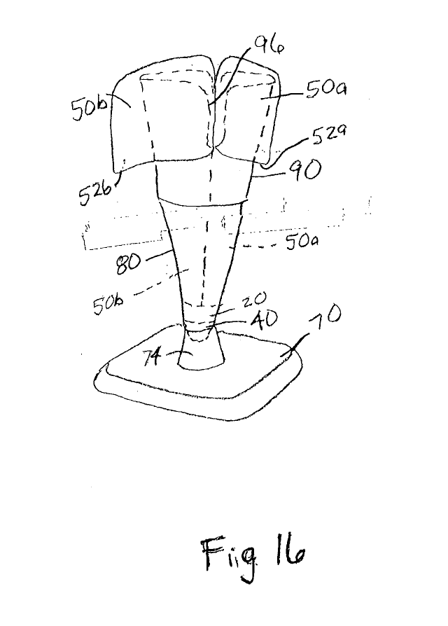

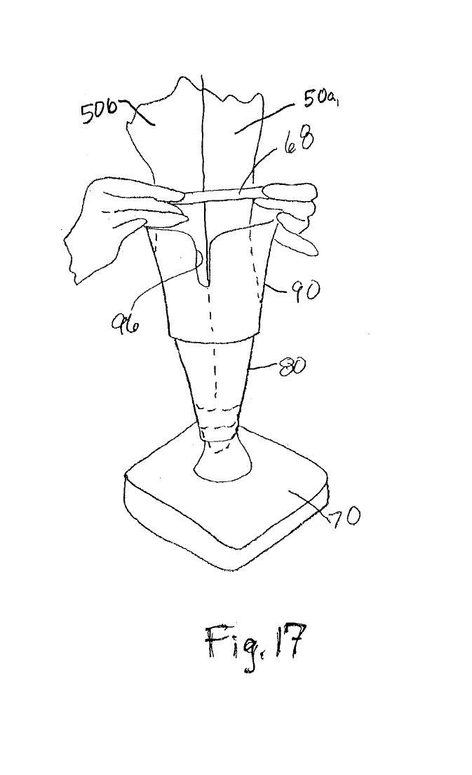

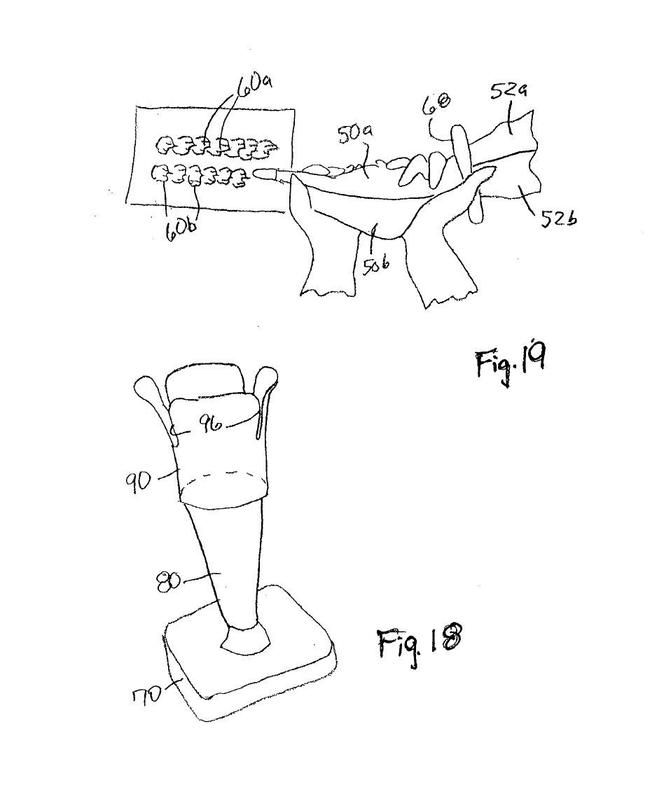

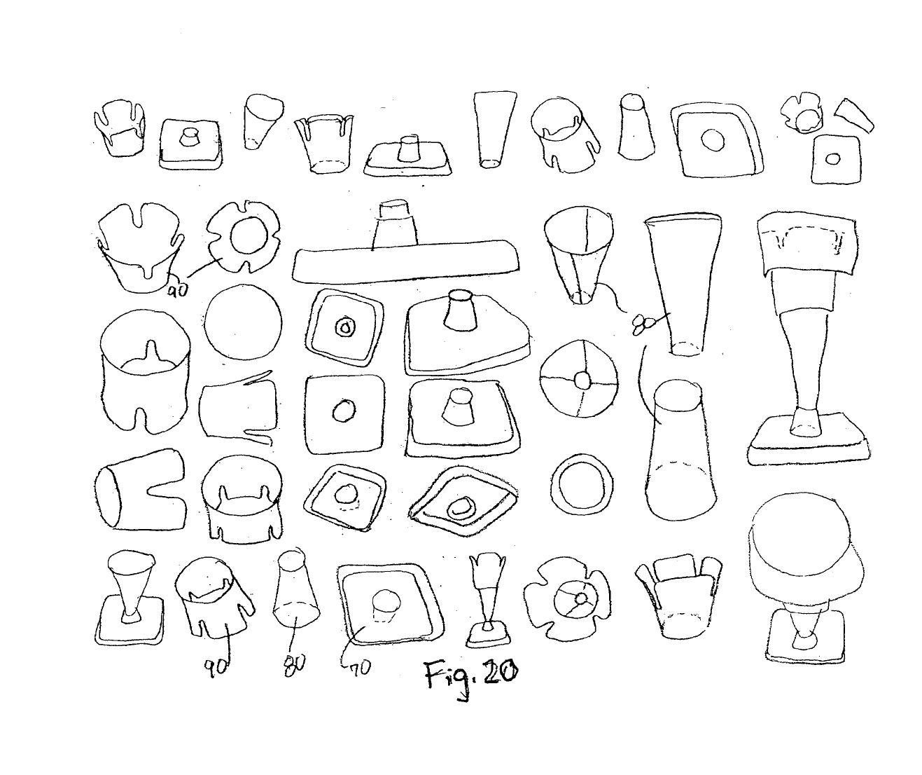

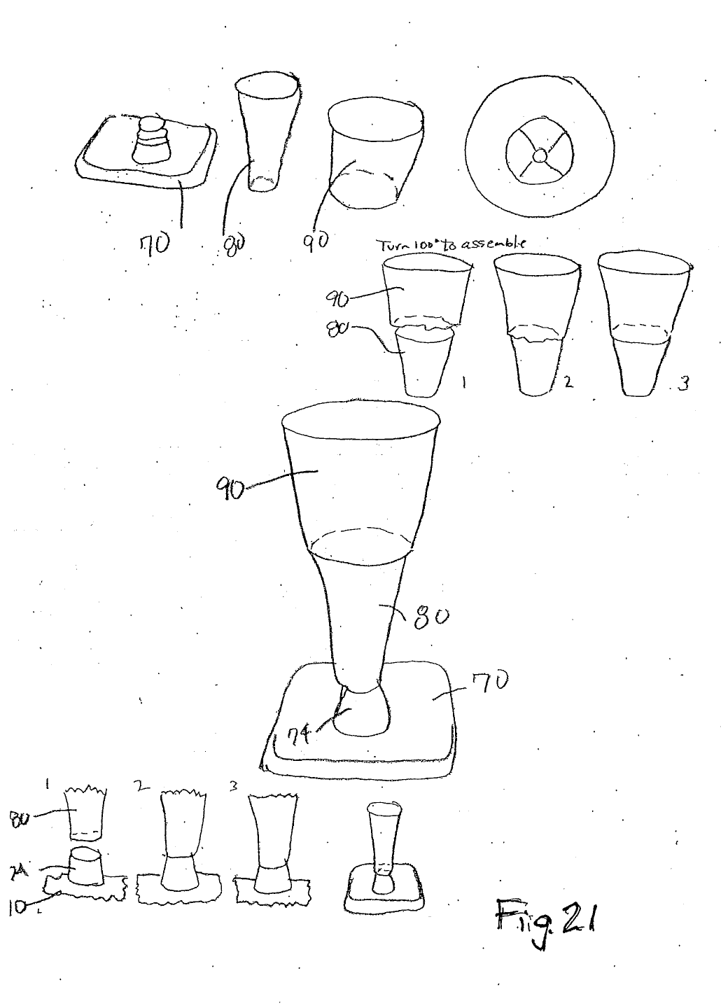

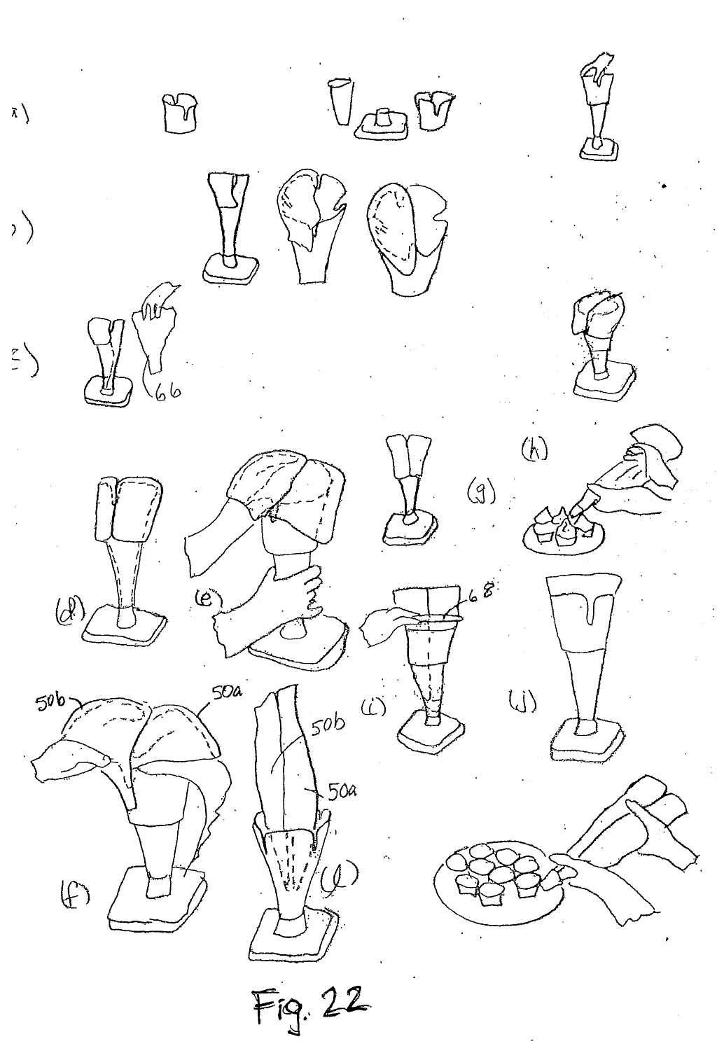

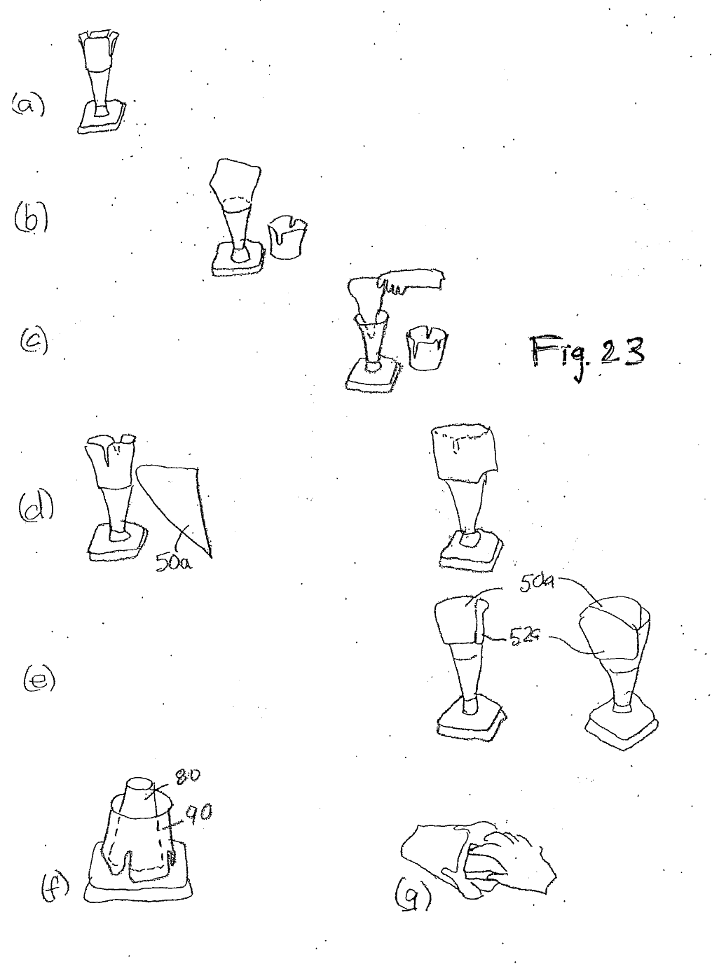

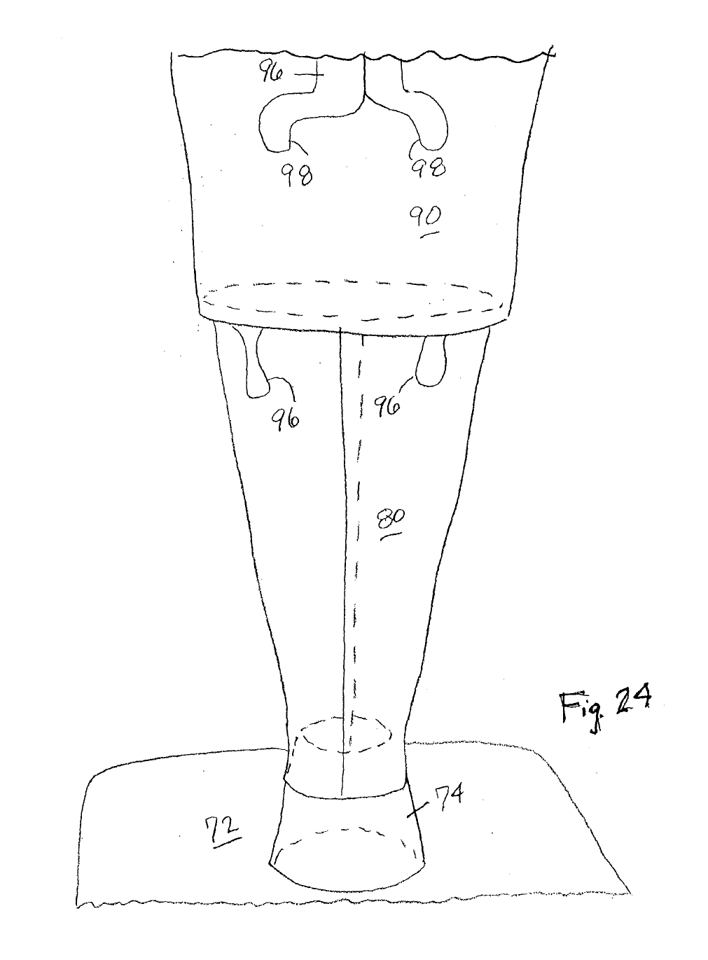

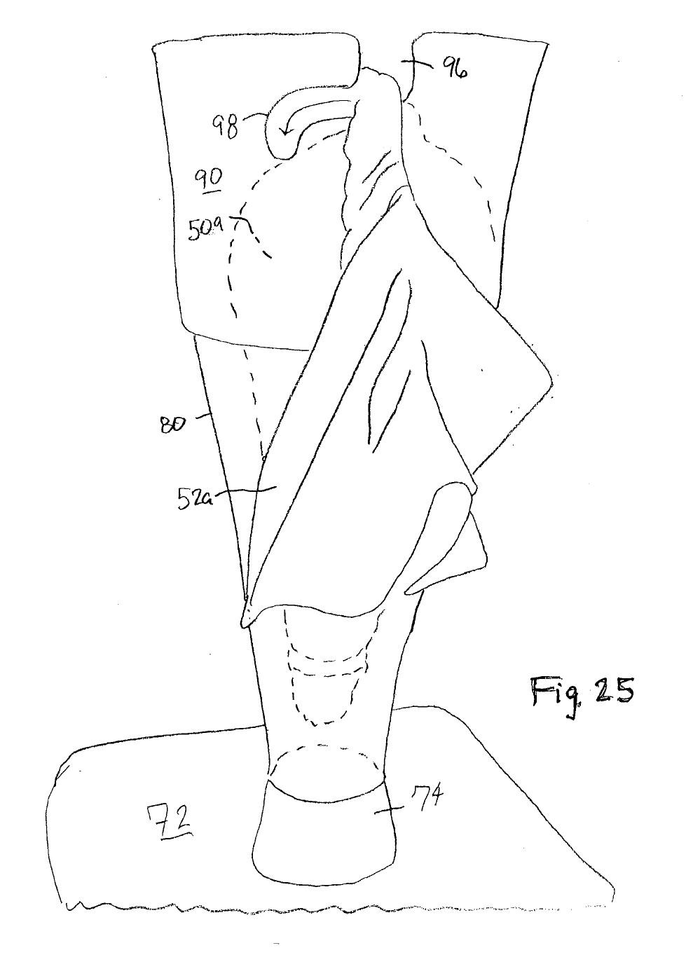

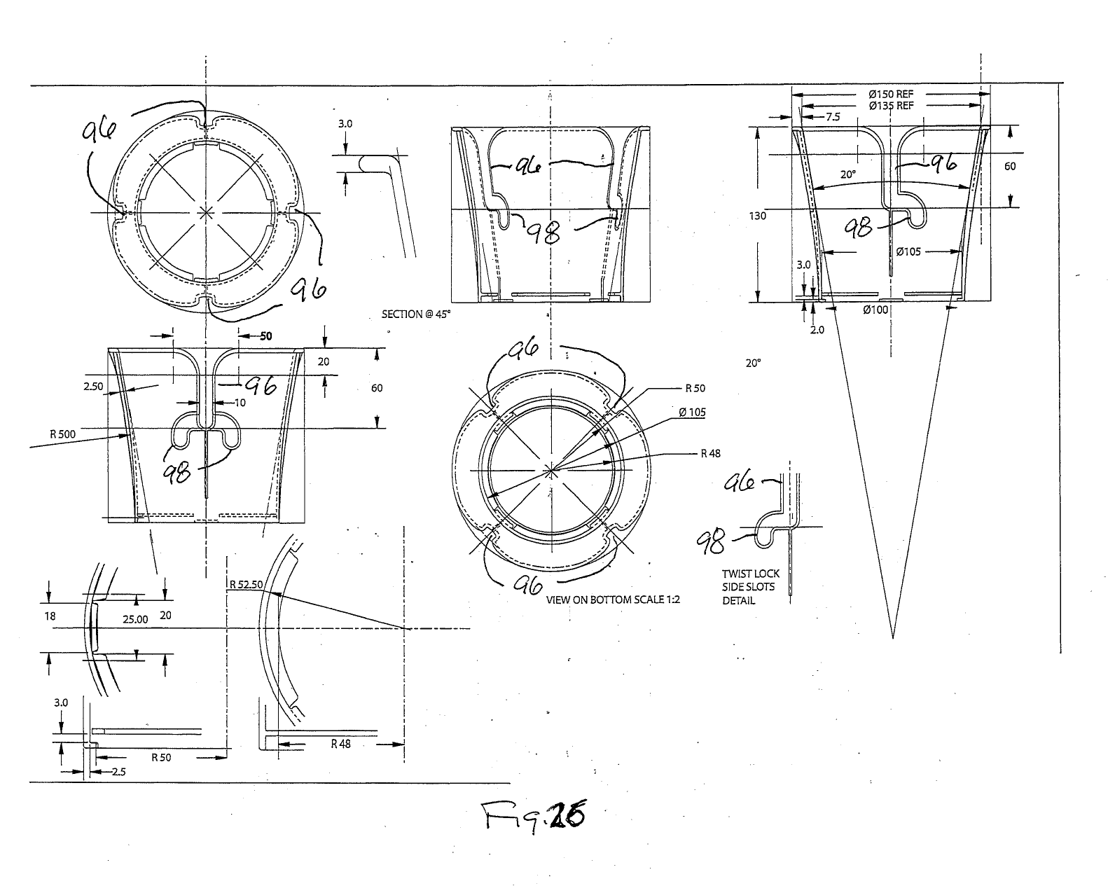

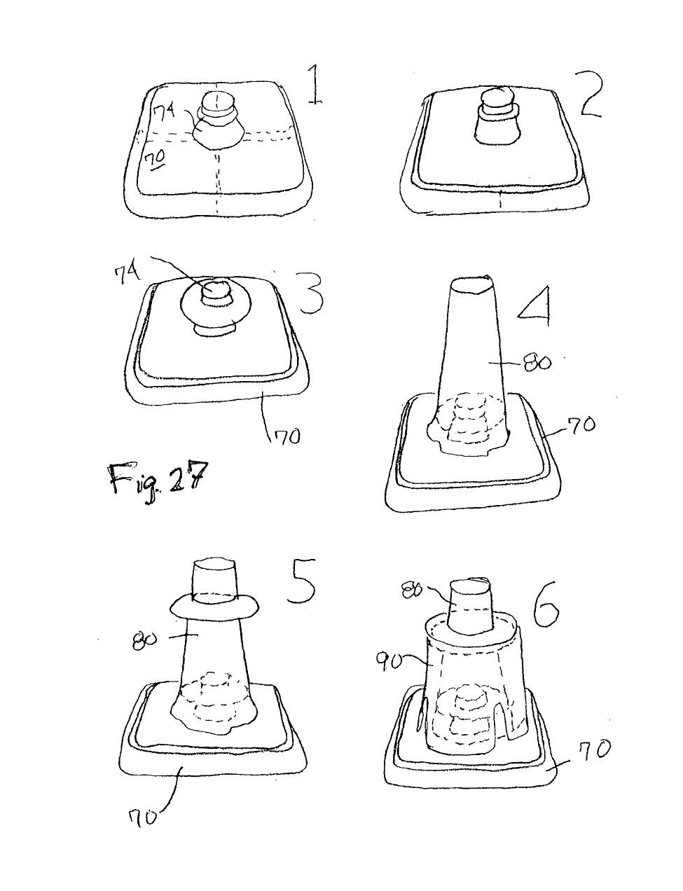

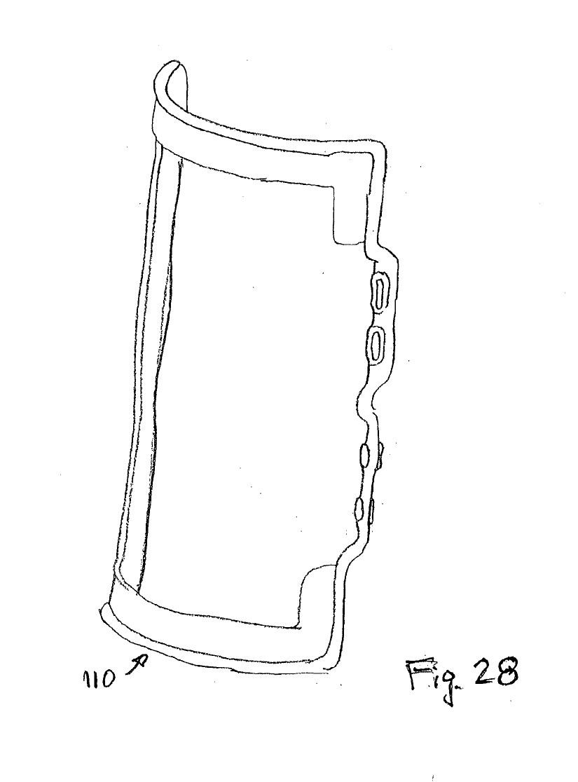

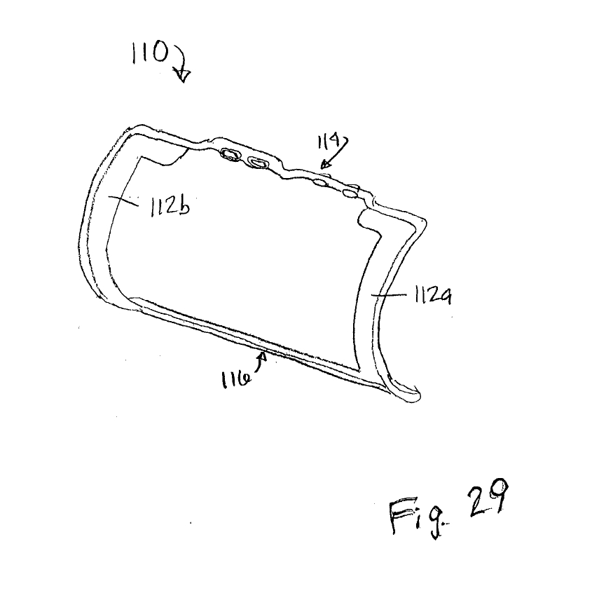

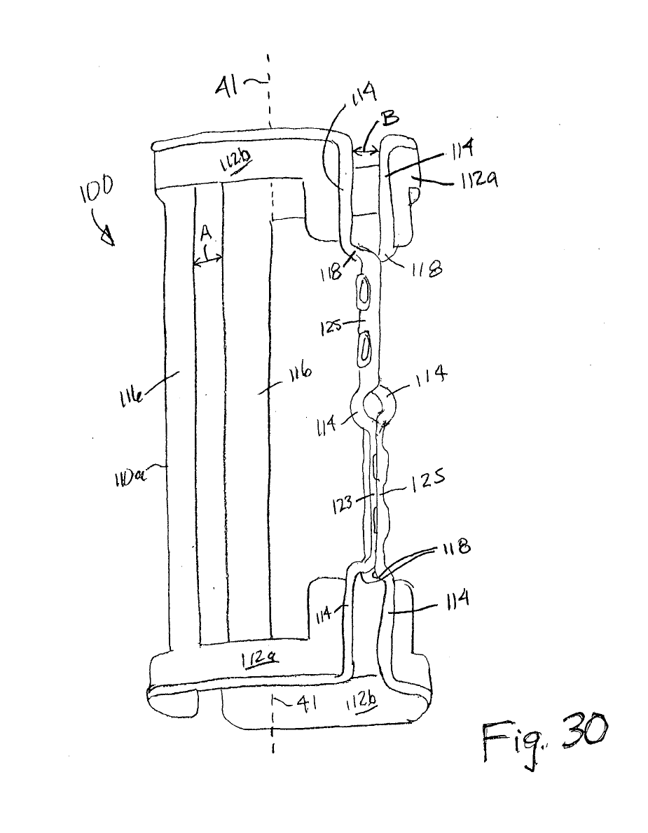

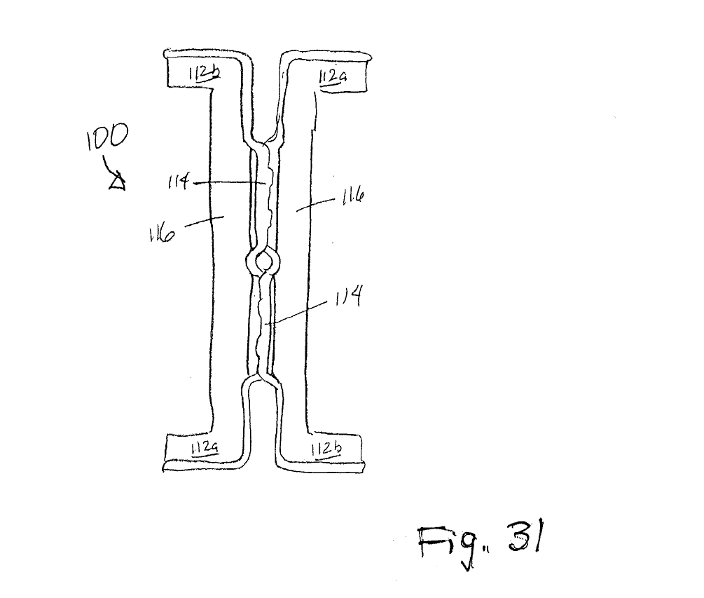

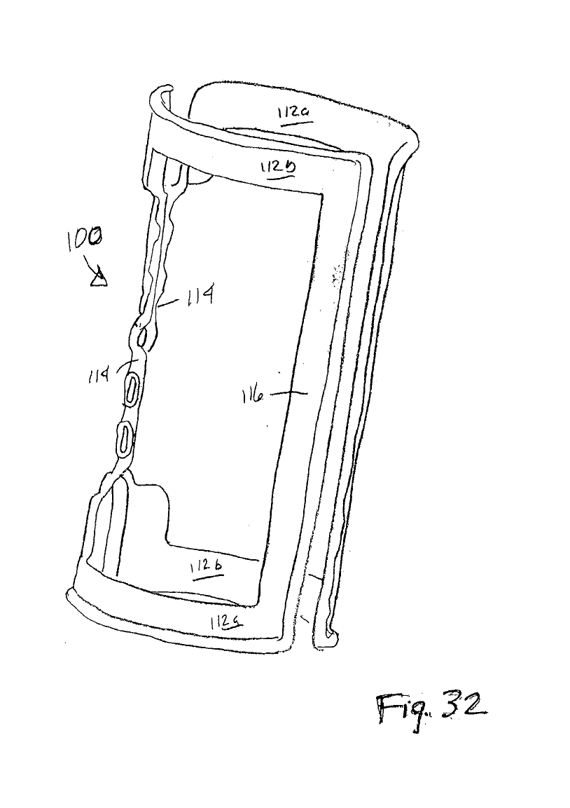

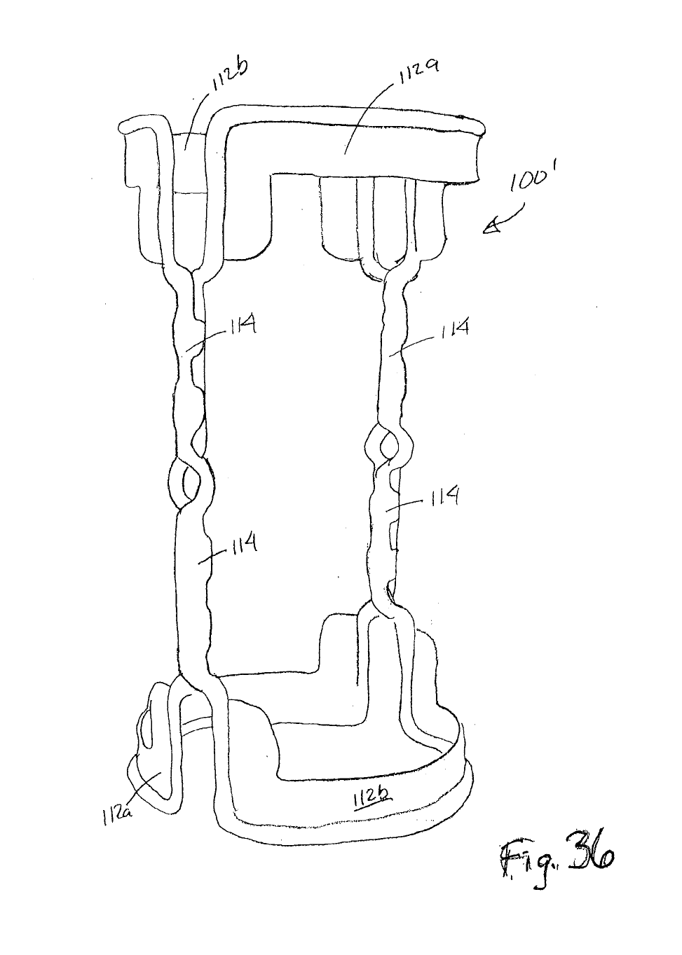

In describing the preferred embodiment of the present invention, reference will be made herein to FIGS. 1-42 of the drawings in which like numerals refer to like features of the invention.

The present invention provides a pair of nozzles to be attached to a pair of piping bags, for example, disposable pouches, so that two (2) different streams of flowable material may be simultaneously expressed and deposited side-by-side at the same time. The nozzle pair is also referred to herein as a “double coupler.” In one aspect the two different streams may form side-by-side lines or similar forms when the nozzles are moved over a surface on which the flowable material is to be deposited, such as when flowing decorative icing over a cake or other pastry item. In another aspect the two different streams may form a surrounded dot when the nozzles are maintained at a stationary position over the surface, where one stream forms a center dot and the other stream forms the surrounding material. Additionally, triple and quadruple nozzles may be employed, with each individual nozzle attached to a separate bag, to simultaneously express and deposit three (3) or four (4) different streams of flowable material side-by-side.

Various types of piping bags may be employed with the double, triple or quadruple coupler nozzles of the invention. The piping bags may have a relatively wide upper end having an opening to receive the flowable material and a narrower, relatively smaller lower end, which slips over the nozzle base, and having an opening to permit flow of material out of the bag. Each nozzle base may be in the form of portions of a tubular or hollow, right circular truncated cone, cut along one or more planes containing the longitudinal axis of the cone. In the case of the double coupler, each nozzle base would be approximately one-half (180 degrees) portion of a hollow body in the form of a substantially right circular truncated cone. In the case of the triple coupler, each nozzle base would be approximately one-third (120 degrees) portion of a hollow body in the form of a substantially right circular truncated cone, or a combination of two one-quarter (90 degrees) and one one-half (180 degrees) portions of a hollow body in the form of a substantially right circular truncated cone. In the case of the quadruple coupler, each nozzle base would be approximately one-quarter (90 degrees) portion of a hollow body in the form of a substantially right circular truncated cone. The nozzles when placed side-by-side have non-planar contacting walls having mutual mating male/female configurations. Before they are joined, a piping bag is slipped over each nozzle, so that the lower bag end fits snugly over some or most of the outer surface of each nozzle. Instead of placing each coupler nozzle base into individual piping bags, the coupler nozzle bases may be placed in a double piping bag which has been sealed vertically down the middle, i.e., one half nozzle base down each side, or in a double piping bag which has been made from three triangles which have been sealed down the diagonals, i.e., one half nozzle base down each triangle.

When placed together side-by-side, the outer or exterior walls of the nozzle bases may form a substantially frusto-conical configuration. A tab is located at bottom of at least one nozzle base to prevent sliding of one nozzle base with respect to the other along longitudinal axis of connected nozzle bases. Each nozzle base has a threaded portion at the larger end and a threaded portion at some mid-point position between the larger end and the smaller end. A retaining ring slips over the two (2) base nozzles when they are side-by-side and connects by the screw-on threads at the base larger ends to hold them in position. In the side-by-side line configuration a dividing flange extends from one or both nozzle bases toward the outlet. In the center dot configuration a tube extends from one nozzle base toward the outlet and the other nozzle base permits flow of material toward the outlet around the tube. In both configurations, a screw-on nozzle tip may be used, such as the nozzle tip employed in U.S. Pat. No. 8,870,040, the disclosure of which is hereby incorporated by reference. The nozzle tip screws to the nozzle bases at the threads at the mid-point of the nozzle bases. As in the '040 patent, bayonet-type threads or interrupted threads may be used for all threads.

The present invention also provides piping bag stands to be used either with the piping bags employing the double coupler nozzle bases, or with piping bags employing other types of nozzles. One piping bag stand is a conical piping bag stand, and another piping bag stand is a smaller open frame-type, which is an improvement over the piping bag stand disclosed in PCT International Application Publication No. WO 2005/067772 A1, the disclosure of which is hereby incorporated by reference.

### Double Coupler Nozzle

Embodiments of the double coupler nozzle of the present invention are shown in FIGS. 1-12 and 13(a) and (b), without the piping bags. Coupled or combined nozzle base 20 is made up of separate nozzle bases 20a and 20b. The nozzle bases have wider upper ends 22a, 22b which are inlets for the flowable material and narrower lower ends 24a, 24b which are outlets for the flowable material. The example shown in. FIGS. 1-6 is of the double coupler that forms a dot of one material flowing from tubular outlet 34 on base 20a, which dot is surrounded by the other material flowing from outlet 24 of base 20b around tube 34 when the nozzles 20a, 20b are maintained at a stationary position over a surface. (If the nozzle bases were of the type that form side-by-side lines or similar forms when the nozzles are moved over a surface, nozzle base 20a would not have tube 34, and the outlet end 24a would be substantially open, as is outlet end 24b of nozzle base 20b.) The outer surfaces 26a, 26b (adjacent the wider end) and 28a, 28b (adjacent the narrower end) are shown as frusto-conical, and external threads 30a, 30b and 32a, 32b are disposed on the walls of respective upper and lower ends. Outer surfaces 26a, 26b and 28a, 28b comprise the exterior or external walls of the respective nozzle bases.

The nozzle bases 20a, 20b have respective contacting internal walls 36a, 36b (also called inner or interior walls) that divide the combined conical nozzle substantially along a plane in which is contained the longitudinal axis 41 thereof. The contacting internal walls are non-planar and have complimentary curved sections 35a (female) and 35b (male) which interlock and help to lock the two bases in relative fixed positions along a radius of axis 41. Tabs 38 extend outwardly from the upper end of internal wall 36b on base 20b and bear against the upper end of internal wall 36a on base 20a to prevent relative movement in one direction between bases 20a, 20b along axis 41.

In FIGS. 4-6, nozzle tip 40 is shown screwed on to threads 32a, 32b (not shown) of combined nozzle base 20. In FIG. 5, retaining ring 48 is shown screwed onto threads 30a, 30b around the wider, upper end of nozzle bases 20a, 20b to hold the bases together. (The retaining ring is not shown in FIGS. 4 and 6.) Nozzle tip 40 has a tubular, generally frusto-conical configuration with internal surfaces generally conforming to the external surfaces 28a, 28b of bases 20a, 20b, with a wider upper end 42 and a narrower lower end 44 having the outlet for the flowable material. Outlet end 44 has a generally circular opening for tube 34 at the outlet 24a of nozzle base 20a, with square notched openings 46 extending radially outward. When the piping bags (not shown) are installed over the separate nozzle bases, with the nozzle bases at the lower outlet ends of the piping bags, material flowing from the piping bag installed over nozzle base 20a will flow out from tube 34 at outlet 24a, while material flowing from the piping bag installed over nozzle base 20b will flow out through outlet end 24a (not shown) inside the lower tip end 44, and then flowing around tube 34 and out through the surrounding notches 46.

Additional embodiments of the double coupler nozzle of the present invention are shown in FIGS. 7-11 and 13(a) and (b). In FIGS. 7 and 8, row (a), various views of transparent plastic nozzle base 20a are shown. Nozzle base 20a is similar to nozzle base 20a of FIGS. 1-6 except that instead of having tube 34, a nozzle base outlet divider wall 37 extends from interior wall 36a at outlet 24a. In FIGS. 7 and 8, row (b), various views of transparent plastic nozzle base 20b are shown, and nozzle base 20b is similar to nozzle base 20b of FIGS. 1-6. Outlet divider wall 37 may be alternatively placed on nozzle base 20b, or on both nozzles bases 20a and 20b. Retaining ring 48 is thicker and stronger in FIG. 7 than in FIG. 8 and, along with nozzle 40 should be of sufficient strength to resist separation force between the two coupler nozzle bases 20a, 20b as the bags are squeezed and the flowable material is extruded. FIG. 9 shows various views of nozzle bases 20a, 20b without the retaining ring and the screw threads for the retaining ring at the upper wide end. The two nozzle base coupler halves 20a, 20b may be secured together with only the screw-on nozzle 40 if the nozzle and screw threads are made sufficiently strong. Rows (c) and (d) of FIGS. 7 and 8 shown nozzle bases 20a, 20b separate and mated together, and shows retaining ring 48 placed over the outlet end of the bases and moved toward the wider inlet ends and screwed in position to hold the bases together.

To assemble the piping bags and double coupler nozzles, a nozzle base is placed through the upper wider end of each conically shaped piping bag, though which flowable material is normally filled, and moved toward the lower end having the outlet through which the material is normally expressed. In row (e) of FIGS. 7 and 8, conically shaped piping bags 50a, 50b, which are made of transparent plastic film filled with different colored flowable material, are shown respectively with the film at their lower outlet ends 52a, 52b fitted snugly over the outside of nozzle bases 20a, 20b. The film at the lower ends of the piping bags 50a, 50b extends beyond the midpoint threads of the bases 20a, 20b and ends adjacent to the nozzle base outlets 24a, 24b. Nozzle bases 20a, 20b are fitted together at their mutual inner walls, with film of the bags between the respective inner walls, and retaining ring 48 is screwed over the piping bag film and the screw threads at upper ends of the nozzle bases. Nozzle tip 40 may then be placed over the piping bag film and then screwed onto the mid-point threads onto the combined bases 20a, 20b. The outlet divider wall 37 permits two different streams of material from piping bags 50a, 50b to be formed side-by-side as lines when the nozzles are moved over a surface on which the flowable material is to be deposited. The outlet opening at the end 44 of nozzle tip 40 forms the overall shape of the emerging material, and may have any configuration such as star-shaped, circular, or any other desired configuration.

The pieces of the center dot-type double coupler of FIGS. 1-6 are shown in various views, disassembled and assembled, in FIGS. 10 and 11. In FIG. 11, row (d) at the right, and in FIG. 12, the center dot type coupler is shown with piping bags 50a, 50b carrying different color decorative icing, with the lower ends of each separately receiving the two nozzle bases 20a, 20b, which are then coupled to form the combined nozzle 20. Upon squeezing the upper ends of the piping bag simultaneously, the different icings are forced out through the lower ends of the bags and through the outlets of the separate nozzle bases 20a, 20b and deposited on a pastry 62. Because the nozzle base 20a has the tubular outlet 24a, to portion of the deposited icing from piping bag 50a forms the dot 60a on the pastry. The icing from the other piping bag 50b flows through nozzle outlet 24b, around tube 34 within the outlet end 44 of nozzle tip 40, and emerges though openings 46 around dot 60a to form a surrounding ring or other form 60b. In this case the openings 46 in nozzle outlet end 44 form a flower shape.

FIGS. 13a and 13b show a prior art double nozzle on the left and an embodiment of the double coupled nozzle of the present invention on the right, with comments in the center column describing differences and advantages of the present invention. The double coupled nozzle shown is of the side-by-side type of FIGS. 7-9, and FIG. 13a, row (c) and FIG. 13b, rows (a) and (b) show the piping bags over the nozzle bases 20a, 20b, and trapped and sealed beneath the retaining ring (FIG. 13a, row (c)).

Referring to FIG. 13(a)(a), if the user doesn't carefully thread the prior art partition into the splints on the inside of the nozzle, it will wither not be fixed properly, or it will be at an angle, which will lead to the end product not turning out how desired. With the nozzles of the invention this does not occur since the nozzles' fastening is not dependent on the partition. As shown in FIG. 13(a)(b), because of the white and milky color of the prior art nozzle, the user isn't able to see where the material is inside the nozzle. The clear color see-through nozzle of the invention allows the user to constantly check the content inside. In FIG. 13(a)(c), if the user wants to switch the prior art nozzle-tip to use and other pattern, the entire construction will fall apart and the user will have to put together the inconvenient design all over. Because of the fixating retaining ring at the end of the nozzle of the invention, the tip is interchangeable with any of the other nozzles from the same range without any difficulty.

As shown in FIG. 13(b)(a), when using the prior art nozzle with two separate bags, the pressure of the filled contents will push the bags apart, and thus put forceful pressure on the nozzles middle. This might cause the nozzle to break. The strong design of the invention can withstand such pressure without any problems. In FIG. 13(b)(b), even if there is just one layer of plastic between the prior art nozzle halves, they are not able to stay together tightly. Material will go inside that gap. With the tight design of the invention, this would not happen. Even without anything between the prior art nozzle halves as shown in FIG. 13(b)(c), they don't fit together tightly; however, the design of the invention fits together tightly. Referring to FIG. 13(b)(d), when prior art nozzle halves are not held together by the tip, they easily slip apart, especially with the piping bag plastic in between, which is a nuisance. The design of the invention is firm and tight.

### Conical Piping Bag Stand

The embodiment of the piping bag stand described herein includes three (3) parts, the base, the bottom cone and the top, fluted cone. The base has an upstanding neck, which is open to permit drips falling within the stand to pass through to the table surface, for easy cleaning. The lower cone having a frusto-conical section may be used with or without the upper cone also having a frusto-conical section. The base and two conical sections may be interconnected by twist-lock mechanisms or other screw-type connection. The upper conical section has flutes or slots extending down from the top edge or rim to form fluted wings to receive the folded-down upper ends of multiple piping bags. The slots may also be used to receive smaller piping bags. The lower conical section may also have such slots when used without the upper section. The slots in the upper conical (or lower) section may have a curved or enlarged section at the lower end to be able to twist the open top end and secure it in the slot.

The double coupler base nozzles are assembled to the piping bags and connected together by the retaining ring before the bags are placed in the stand. The base nozzles may hang loosely in the neck of the piping stand base while the piping bags are filled.

An embodiment of the conical double piping bag stand is shown in FIGS. 14-27, in which all components are shown made of transparent plastic. As an alternative to transparent plastic, other materials may be used. Base 70 has a top surface that is spaced by downward flanges on each of the four sides to elevate it above the table top on which it is placed. Neck 74 extends upward from top surface 74 and is open internally to permit drippings to pass to the table top. Threads 76 at the upper end of neck 72 mate with lower threads 82 on lower cone 80, which has a tubular, generally frusto-conical configuration extending from a smaller diameter at the bottom end to a wider diameter at the top end. Upper threads 84 mate the lower cone with lower threads 92 of the upper cone 90, which likewise is of tubular, generally frusto-conical configuration. The wider upper end of upper cone 90 is open and the peripheral rim or lip thereof has multiple slots 96 extending downward a substantial portion of the vertical length of the upper cone. The portions of the upper end of upper cone 90 between slots 96 form separate wings to support the piping bags upper ends. After connection to a nozzle base 20 as described previously, a piping bag 50a, 50b may be placed in the conical stand with the narrower lower end 54a, 54b and nozzle 20 hanging within the lower cone 80 or base neck 74, and the wider upper end 52a within or folded over top lip 94 of upper cone 90. When more than one piping bag is simultaneously held by the conical piping bag stand, the upper ends 52a, 52b of the piping bags may be folded-down and slid within slots 96. Two (2) piping bags are shown in FIGS. 15-17, and only two (2) slots 96 are required to separately hold the piping bags. However, four (4) slots 96 are shown in these figures and in FIG. 14, and additional slots may be provided.

The individual conical piping bag stand components as described above are shown in various views in FIG. 20, and the top cone in particular is shown in various views in FIG. 14. Initial packaging of the components for shipment is shown in FIG. 27, where the base (1) has placed over the top surface a cardboard protector with an opening for the neck (2), a circular cardboard protector is placed over the top of the neck below the neck screw threads (3), and the lower cone is inverted and placed over the neck and neck-cardboard with the circular cardboard being the inner diameter of the lower cone (4). A circular, cardboard protector is placed over the top of the inverted lower cone (5), and finally the upper cone is inverted and nested or placed over and around the lower cone, with the lower cone cardboard being the inner diameter of the upper cone (6). The packaged components may then be placed inside a box for safe shipment without damage. In addition to safe and easy transport, the components may be separated and nested within each other as shown for or storage, with or without the cardboard protectors.

Assembly of the individual conical piping bag stand components is shown in the lower right of FIG. 20, in FIG. 21 and in the upper row (a) of FIG. 22. The threads between the base neck and the lower cone and the lower and upper cones may be bayonet type- or interrupted threads that require rotation of less than 180 degrees to assemble, for example, 100 degrees as shown. The bottom cone can be twisted into the base and the top cone into the bottom cone, using a bayonet thread system, similar to the bayonet thread system used on the nozzles. The assembled conical piping bag stand is shown in FIG. 18, FIG. 21 center, FIG. 22 upper right and FIG. 23 upper left. Just the bottom part screwed into the base can be used for piping bags of smaller diameters. Additionally, just the bottom part could be used with or without the base part for the purpose of using it as a hopper and/or funnel.

Operation of the piping bags stand and the double coupler nozzle of the present invention are shown in FIGS. 16, 17, 18, 19, 22(a)-(l) and 23(a)-(g). The three (3) part conical piping bag stand are assembled as described above. After the individual piping bags are connected to the individual nozzle bases, with the nozzle bases are combined to form the double coupler nozzle as described above, the empty piping bags are placed into the upper cone. Where two bags are used in the double coupler nozzle system, it is possible to stretch one bag over two wings and the other bag over the other two wings, thereby making the filling of both bags with two different colored mixtures at the same time easy. The bags are placed so that the double coupler nozzle hangs down into the lower cone or neck; and the upper ends of the bags are folded down so that a portion of each is outside the upper cone and the remaining portion of each is in placed downward in opposed slots and contacting each other diametrically across the center of the upper cone (FIG. 22 rows (b) and (c)). When filling larger bags, both the lower and upper cones of the piping bag stand may be used. The fluted wings of the top cone, allows for a smaller bag diameter to be stretched over one to four of the wings. The individual piping bags are then filled sequentially (FIG. 22(j)) with the desired amount of material, for example icing (FIG. 16 and FIG. 22 (d) and (g), and the upper ends of the piping bags are folded upward out of the upper cone slots (FIG. 22(e), (f) and removed by pulling upward out of the stand (FIG. 22(l)). A clip 68 may be placed over the upper ends of the piping bags to close and secure them together (FIG. 17, FIG. 22(i)). Alternatively, the individual piping bags are placed with their individual nozzles into the piping bag stand without their nozzles combined, and the nozzles are combined after the bags are filled and removed from the stand. A piping bag clip 68 may be used to secure the upper open ends of the piping bags together (FIG. 17, FIG. 22(i)).

FIGS. 24-26 show a modification of the slots extending downward from the upper peripheral lip of upper cone 90. Slot 96 has at its lower end an additional curved portion 98, which first extends substantially horizontally and then extends substantially vertically downward. Instead of using a clip to close the upper end 52a of piping bag 50a after filling, the upper end may be twisted closed and slid downward through slot 96 and into curved portion 98 (FIG. 25), where it may be held or parked temporarily until the piping bag and nozzle are removed from the stand. Alternatively, the slots may have an enlarged lower end of diameter greater than the width of the slot to permit the upper end of the bag to be removed from over the wings, twisted and re-inserted into a slot enlarged lower end to hold the upper end of the bag closed. To accommodate smaller piping bags, the upper cone may be removed and slots may be placed and similarly used in the upper peripheral lip of lower cone 80, as in FIGS. 24 and 25.

The conical piping bag stand of the present invention may also be used with a single piping bag, and the upper end is folded down so that it surrounds the entire periphery of the upper cone (FIG. 23 rows (a), (d) and (e)), or if a smaller bag is used only the periphery of the, lower cone without the upper cone attached (FIG. 23 rows (b) and (c)). In addition to plastic film bags, the conical piping bag stand may be used to hold other types of flexible bags such as those made from cloth, silicone or reusable materials.

Numerous advantages are obtained by the piping bag stand of the present invention. The fluted wing system in the stand allows for more than one bag to be folded over the wings of the upper cone and held in place simultaneously for filling in different mixtures. The diameter of the piping bag stand can be varied to incorporate a given number of “wings” to allow for one or more bags to be held in place at the same time. While the drawings shows four wings, the number of wings could be two, three, four or more, depending on the width of the bags one wishes to use. The fluted wings in the top part can not only be used for a good hold when filling one or more bags, but also as a unique storage option. When a piping bag is in use, one can simply twist the end and induct that twisted part into the curved slots between the flutes which are configured so that they can offer an improved hold to the bag (see FIGS. 24 and 25).

The entire piping bag stand is also designed in a way that makes it especially hygienic. There are no little pits or holes, where food excrements or dirt pieces can get stuck. The whole device is very easy to wash. It is also elevated, so that it is possible to stand it on different surfaces without having to worry about the nozzle touching anything it shouldn't while the bag isn't in use. There is also no fixture to close off the space beneath the nozzle. This means that any mixture which drips out from the nozzle will drip straight onto the table surface rather than into an enclosed hole which is difficult to clean. One could place the stand onto a silicon mat or tray, which could then be removed for easy cleaning after use.

The piping bags using the double coupler nozzle may be used by holding the nozzle or lower portion of the piping bags in one hand and squeezing the two filled piping bags together with the other hand (FIG. 22(k)) so that the material in the two piping bags is expelled simultaneously and side-by-side on the pastry or other surface. When filling both sides of a double piping bag (i.e. three (3) triangles of film welded down the diagonals or a single piping bag which has been welded down the length) in the piping bag stand, it is not always possible to insure that the mixtures continue to flow down to the nozzle, ready for pressing out. Sometimes the filling can get stuck inside the bag and needs some manual pressure to get the flow started. For this purpose, in the present invention one filled bag side can then be gripped and the mixture pressed down the bag by hand, so that it can be pressed out of the nozzle end. The same action can be done for the second bag. Once the material has been pressed down to nozzle level in both bags, the two bags can be brought together into the hand and the mixtures pressed through the nozzle end as required. If employing the double coupler nozzle of FIGS. 1-6, the nozzles is maintained over one position over the surface, and optionally moved up and down so that one stream forms a center dot and the other stream forms the surrounding material, as in FIG. 12. If employing the double coupler nozzle of FIGS. 7-11 and 13(a) and (b) the nozzles are moved over the surface and optionally moved up and down to form the two different streams in side-by-side lines or similar forms, as in FIG. 19 and FIG. 22(h).

### Triple and Quadruple Coupler Nozzles

As an alternative to the above-described double-coupler nozzle using two bags and expressing two different streams of flowable material, the nozzle of the present invention may be made as a triple or quadruple coupler using a nozzle base in three or four sections, and using three or four bags, whereby the three or four nozzle base pieces of the coupler are held together and secured with the nozzle tip and retaining ring, and used to decorate in multiple colors. In the case of a triple nozzle, each one of the three nozzle bases may be in the form of one-third (120 degrees) portion of a tubular or hollow, right circular substantially truncated cone, cut along planes containing the longitudinal axis 41 with the interior wall having an included 120 degree angle, or two one-quarter (90 degrees) and one one-half (180 degrees) portions of a tubular or hollow, right circular substantially truncated cone, cut along planes containing the longitudinal axis 41 with the interior wall having an included 90 and 180 degree angles. In the case of a quadruple nozzle, each one of the four nozzle bases may be in the form of one-quarter (90 degrees) portion of a tubular or hollow, right circular substantially truncated cone, cut along planes containing the longitudinal axis 41 with the interior wall having an included 90 degree angle.

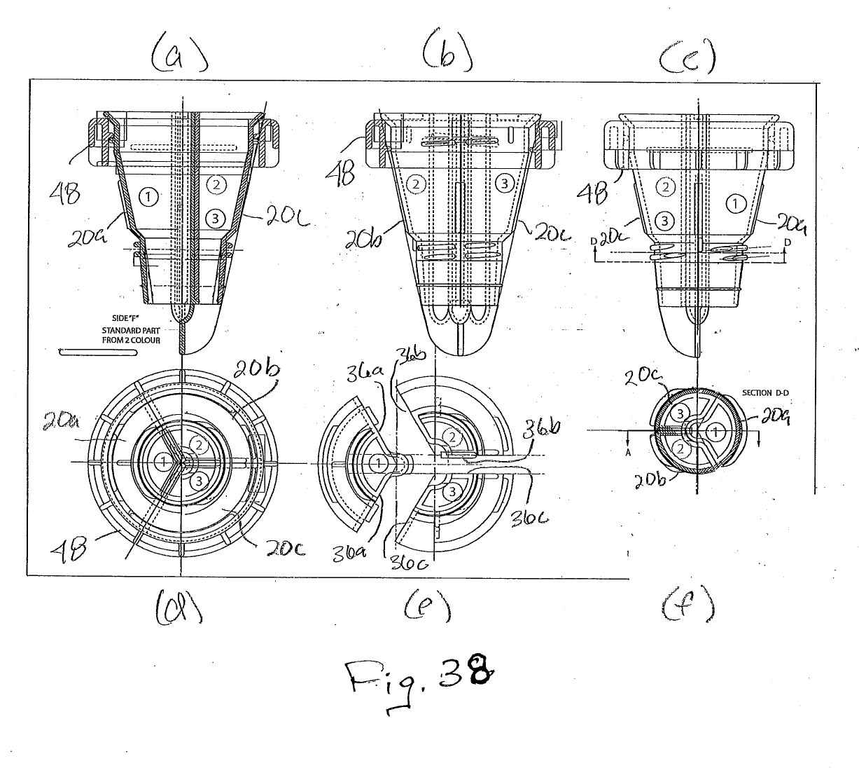

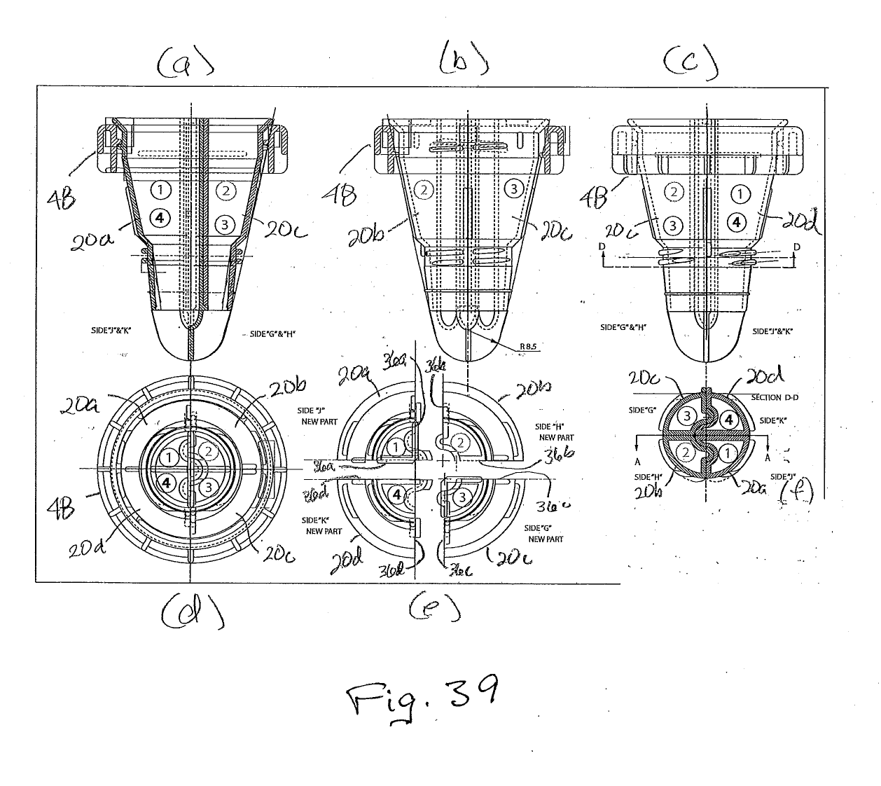

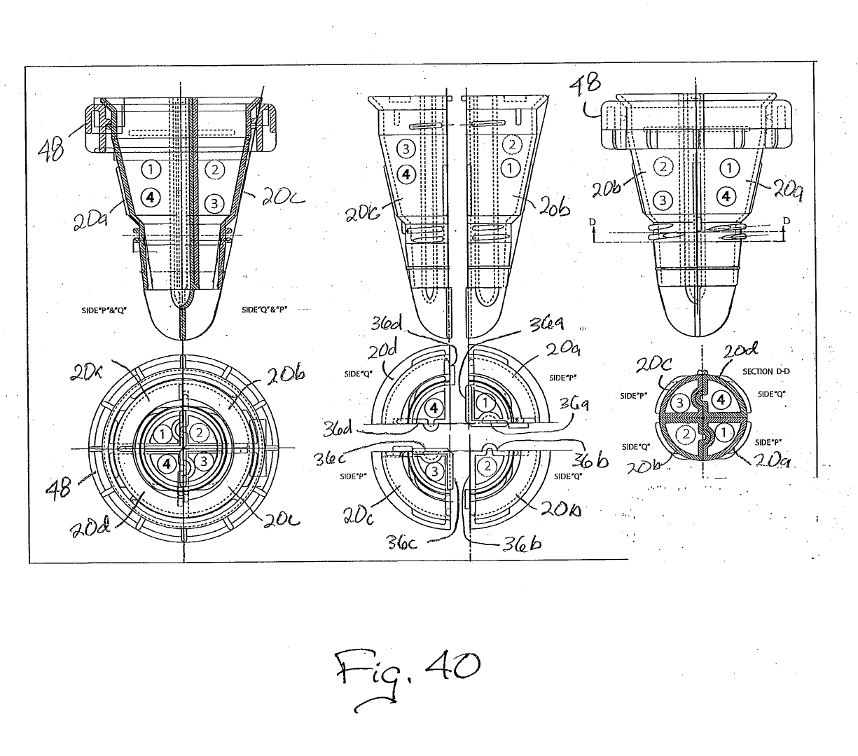

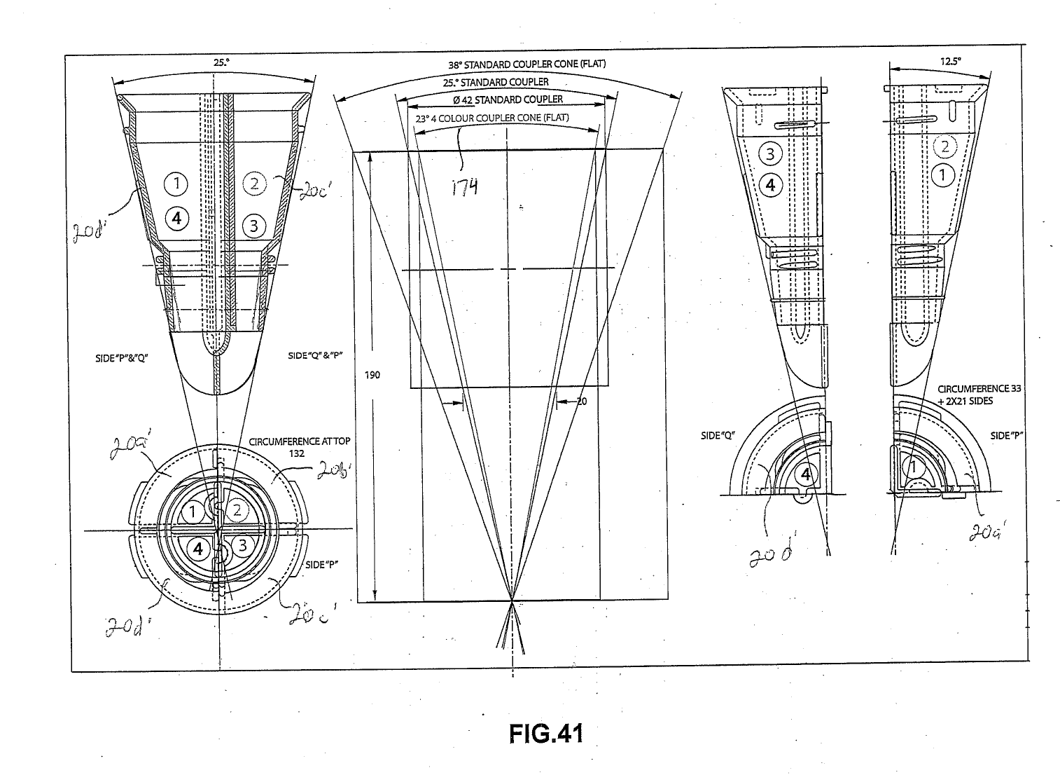

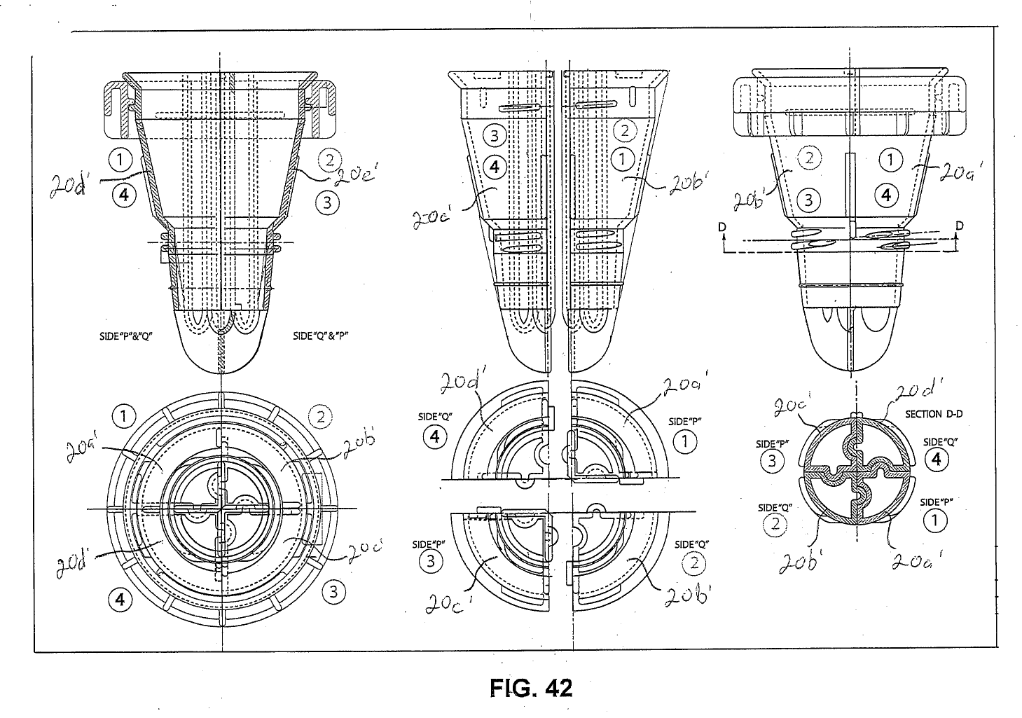

Embodiments of the triple coupler nozzle of the present invention are shown in side elevational and end views in FIGS. 37 and 38, and embodiments of the quadruple coupler nozzle of the present invention are shown in side elevational and end views in FIGS. 39 and 40, all without the piping bags. FIG. 37 shows triple nozzle base sections 20a, 20b, 20c, where base 20a forms about one-half or 180 degrees, and bases 20b and 20c each form about one-quarter or 90 degrees, of the substantially conical form of the coupled nozzle. FIG. 38 shows triple nozzle base sections 20a, 20b, 20c, where each of the bases 20a, 20b and 20c form about one-third or 120 degrees of the substantially conical form of the coupled nozzle. FIGS. 39 and 40 show quadruple nozzle base sections 20a, 20b, 20c, 20d where each of the bases 20a, 20b, 20c and 20d form about one-quarter or 90 degrees of the substantially conical form of the coupled nozzle. In each instance the contacting interior walls 36a, 36b, 36c, 36d of the nozzle bases divide the combined conical nozzle substantially along a plane in which is contained the longitudinal axis 41 thereof and have sections that are non-planar and are complimentary curved to form male/female interlocking members as in the double couple nozzle to help lock the three or four bases in relative fixed positions along a radius of axis 41. FIGS. 41 and 42 show another embodiment of quadruple nozzle base sections 20a′, 20b′, 20c′ and 20d′ whereby each of the four section are substantially identical. FIG. 41 shows the flat angle 174 of the piping bag that would be required to fit the quadruple coupler individual segments.

### Small Piping Bag Stand

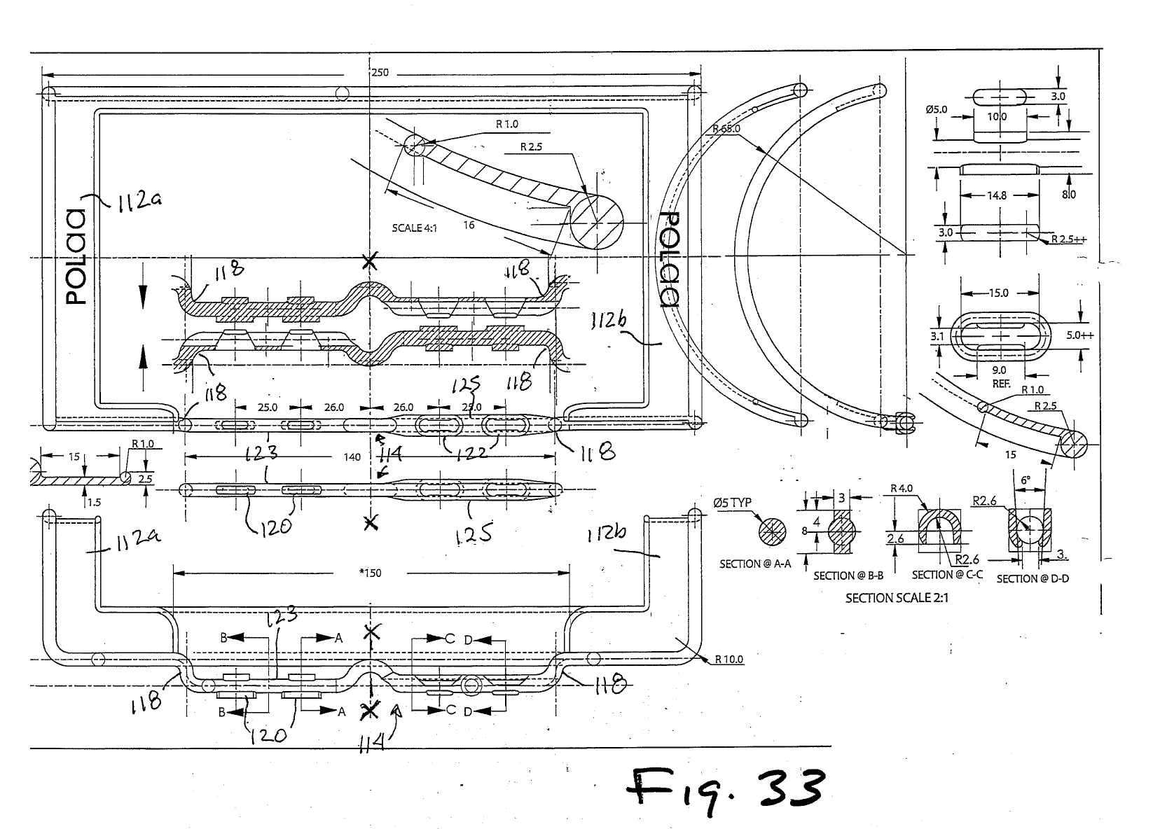

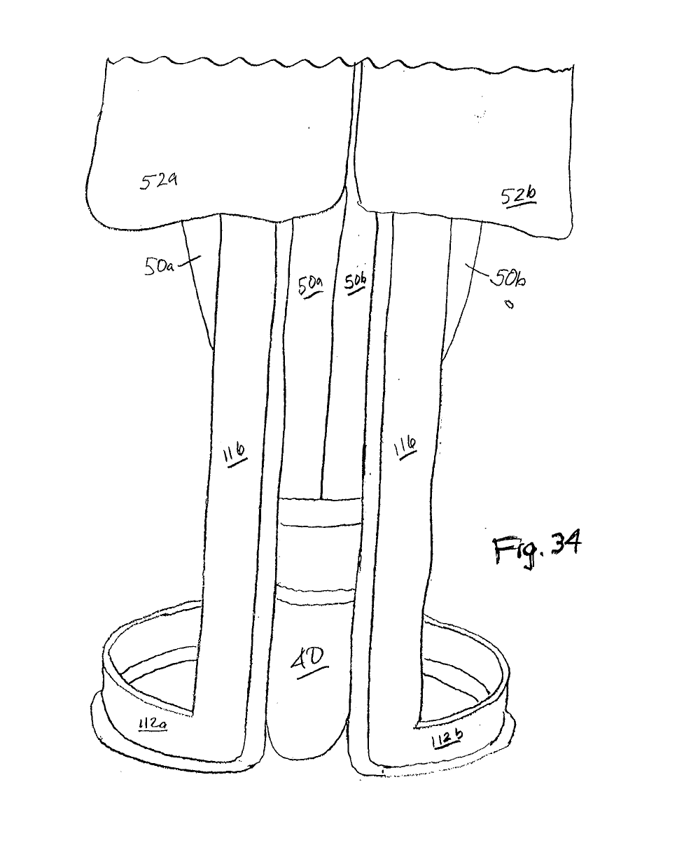

Although not limited to such, embodiments of a portable stand that may be used for pairs of smaller piping bags are shown in FIGS. 28-36. In a first embodiment, the portable stand 100 is made of two (2) identical segments 110 each having end rim portions 112a, 112b of arcuate configuration, forming a portion of a circle, when viewed along longitudinal axis 41. The end rims are joined by locking rib 114 and a non-locking rib 116. Non-locking rib 116 is substantially straight without further features. Locking rib 114 is substantially straight, except for a lateral offset 118 between the end portions that contact and extend from the opposite end rims 112a, 112b and the central portion containing the locking features. The central portion of locking rim includes major protrusion 120 projecting from the outer surface of first central portion 123. The protrusions 120 are located predetermined distances on one side of a reference datum X-X at the mid-point of locking rib 114, and correspondingly shaped recesses 122, sized to receive and hold the protrusions 120, are extend into second central portion 125 and are located at the same, predetermined distances on the opposite side of reference datum X-X (FIG. 33). When assembled as shown in FIGS. 30-32, with stand segment 110b inverted with respect to stand segment 110a and the two locking ribs 114 married together in mutually aligned relation, the protrusions 120 of stand segment 110a are in registry with and locked into the recesses 122 of the stand segment 110b.

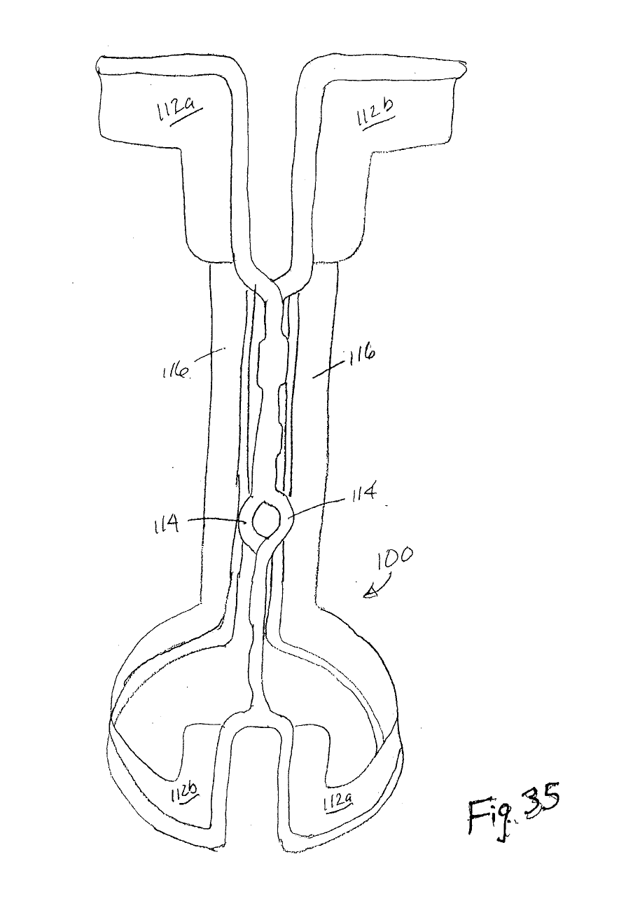

In addition to gap A between non-locking ribs 116 of segments 110a and 110b in the assembled position of FIGS. 30-32 and 35, there also exist circumferential gaps B between the locking ribs 114 at the upper and lower ends of the segments 110a, 110b, which gaps B are formed by the lateral offset 118 between the end portions that contact and extend from the opposite end rims 112a, 112b and the central portions 123, 125 containing the locking features on ribs 114. The circumferential gap B extending from the end rims forms a slot at opposite sides of the stand 100, which serves the same function as slot 96 in the upper cone of the conical piping bag stand described above, i.e., it permits two piping bags to be held in stand 100, with the upper ends of each bag folded down and held within the two gaps A and B between the rims 112a, 112b at the upper end of the stand, as in FIG. 34.

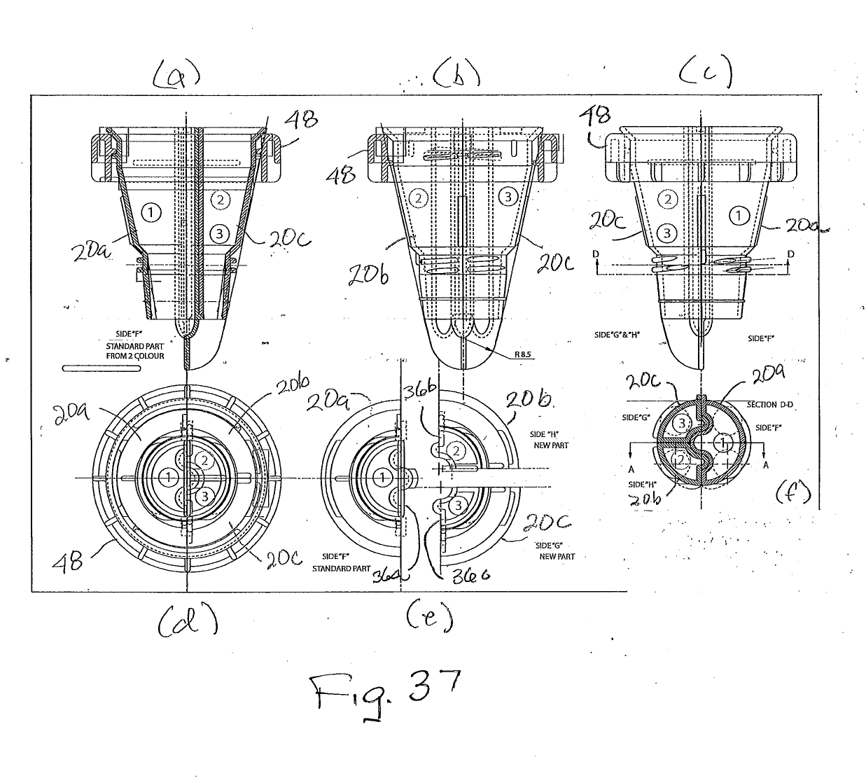

An alternative portable stand 100′ for piping bags is shown in FIG. 36, wherein another set of locking ribs 114 are substituted for non-locking ribs 116, so that both sides of the stand have locking ribs. Because each locking rib 114 has offset 118, each side of both the upper and lower ends of the stand have gaps B, so the upper pair of gaps B may receive the folded down upper sections of two piping bags held within the stand.

In addition to holding piping bags for filling, the portable stand may also be used as a stand for filling non-conical flexible film bags, such as freezer bags. Also, the portable stand may be used to hold other types of flexible bags such as those made from cloth, silicone or reusable materials.

### Numbered Features:

20 combined nozzle base
20a/b separate nozzle base
22a/b nozzle base inlet
24a/b nozzle base outlet
26a/b nozzle base outer surface or exterior wall at upper, wide end
28a/b nozzle base outer surface or exterior wall at lower, narrow end
30a/b external threads on base upper end
32a/b external threads on base lower end
34 tube on nozzle base 20b
35a/b curved portion of nozzle base internal contacting wall
36a/b nozzle base internal, inner or interior contacting wall
37 nozzle base outlet divider wall
38 tab on lower end of base inner wall
40 nozzle tip
41 longitudinal axis
42 nozzle tip upper wide end
44 nozzle tip lower outlet end
46 nozzle tip notches around opening
48 retaining ring
50a/b piping bags
52a/b piping bag upper end
54a/b piping bag lower end
60a/b deposited icing
62 pastry
68 piping bag clip
70 base
72 base top
74 neck
76 neck threads
80 lower cone
82 lower cone lower threads
84 lower cone upper threads
86 lower cone upper slots
90 upper cone
92 upper cone lower threads
94 upper cone upper lip
96 upper cone upper slot
98 upper cone slot extension
100 piping bag stand
110 piping bag stand segment
112ab End rim portion
114 locking rib
116 non-locking rib
118 rib offset
120 major protrusion
122 recess
123 first central portion

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A double coupler nozzle system for sealing to a pair of flexible film bags (or to a double bag, i.e. three (3) triangles of film welded down the diagonals or a single piping bag which has been welded down the length) having a wider upper end and a conical lower end with an opening for flowable material inside the bag and for expressing the flowable material, the system comprising:
a pair of hollow nozzle bases each having an exterior wall and an interior wall and being coupled together along the interior walls, the exterior wall of each nozzle base forming a portion of a substantially right circular truncated cone with a larger diameter end and a smaller diameter end and cut along a plane containing the longitudinal axis of the cone, the interior wall of each nozzle base being non-planar and spanning edges of the exterior wall to form an inlet opening adjacent the nozzle base larger diameter end and an outlet opening adjacent the nozzle base smaller diameter end, the nozzle base interior walls extending inward or outward (or male/female) and complimenting each other when the bases are coupled together along the interior walls;
each of the nozzle bases adapted to be received snugly within the conical lower end of one of the bags with the film of the lower end of the bag extending over the exterior and interior walls of the nozzle bases and having a lower bag edge ending intermediate the larger and smaller diameter ends of the nozzle base, and having film of the bags between the respective interior walls of the coupled nozzle bases;
the coupled nozzle bases permitting side-by-side simultaneous flow of material from bags sealed to the nozzle bases and out of the outlets of the coupled nozzle bases.

2. The double coupler nozzle system of claim 1 further including a retaining ring secured around the exterior walls of the coupled nozzle bases adjacent the larger diameter ends of the nozzle bases, the retaining ring preventing separation of the coupled nozzle bases and sealing the lower ends of flexible bags extending over the exterior and interior walls of the nozzle bases.

3. The double coupler nozzle system of claim 1 further including a tab extending from one of the nozzle base interior walls and contacting the other of the nozzle bases to prevent relative movement of the nozzle bases in a direction along the longitudinal axis.

4. The double coupler nozzle system of claim 1 wherein the complimenting inward or outward (or male/female) extension of the nozzle base interior walls when the bases are coupled together is sufficient to prevent relative movement of the nozzle bases in a direction perpendicular to the longitudinal axis.

5. The double coupler nozzle system of claim 1 further including a tubular outlet at the smaller diameter end of one of the nozzle bases, the tubular outlet permitting outflow of a first material from a bag sealed to the one of the nozzle bases while a second material flows from a bag sealed to the other of the nozzle bases around the first material.

6. The double coupler nozzle system of claim 1 further including a nozzle tip extending over the smaller diameter ends of the coupled nozzle bases, the nozzle tip sealing around the film of the lower ends of the bags around the exterior walls of the coupled nozzle bases and having an outlet opening to permit side-by-side simultaneous flow of material from the bags.

7. The double coupler nozzle system of claim 1 further including:
a third hollow nozzle base having an exterior wall and an interior wall and being coupled together with the pair of hollow nozzle bases along the interior walls, the exterior wall of each nozzle base forming a portion of a substantially right circular truncated cone with a larger diameter end and a smaller diameter end and cut along a plane containing the longitudinal axis of the cone, the interior wall of each nozzle base being non-planar with an included 120 degree angle and spanning edges of the exterior wall to form an inlet opening adjacent the nozzle base larger diameter end and an outlet opening adjacent the nozzle base smaller diameter end, the nozzle base interior walls extending inward or outward (or male/female) and complimenting each other when the bases are coupled together along the interior walls, wherein the third nozzle may be sealed with a third flexible film bag;
each of the nozzle bases adapted to be received snugly within the conical lower end of one of the bags with the film of the lower end of the bag extending over the exterior and interior walls of the nozzle bases and having a lower bag edge ending intermediate the larger and smaller diameter ends of the nozzle base, and having film of the bags between the respective interior walls of the coupled nozzle bases;
the coupled nozzle bases permitting side-by-side simultaneous flow of material from bags sealed to the nozzle bases and out of the outlets of the coupled nozzle bases.

8. The double coupler nozzle system of claim 1 further including:
a third and a fourth hollow nozzle base each having an exterior wall and an interior wall and being coupled together with the pair of hollow nozzle bases along the interior walls, the exterior wall of each nozzle base forming a portion of a substantially right circular truncated cone with a larger diameter end and a smaller diameter end and cut along a plane containing the longitudinal axis of the cone, the interior wall of each nozzle base being non-planar with an included 90 degree angle and spanning edges of the exterior wall to form an inlet opening adjacent the nozzle base larger diameter end and an outlet opening adjacent the nozzle base smaller diameter end, the nozzle base interior walls extending inward or outward (or male/female) and complimenting each other when the bases are coupled together along the interior walls, wherein the third and fourth nozzle may be sealed with a third and fourth flexible film bag, respectively;
each of the nozzle bases adapted to be received snugly within the conical lower end of one of the bags with the film of the lower end of the bag extending over the exterior and interior walls of the nozzle bases and having a lower bag edge ending intermediate the larger and smaller diameter ends of the nozzle base, and having film of the bags between the respective interior walls of the coupled nozzle bases;
the coupled nozzle bases permitting side-by-side simultaneous flow of material from bags sealed to the nozzle bases and out of the outlets of the coupled nozzle bases.

9. A stand for supporting and filling with flowable material one or more flexible bags having a wider upper end and a conical lower end, the lower end optionally connected to a nozzle for expressing the flowable material, the stand comprising a housing with a substantially conical interior having a larger diameter at an upper end thereof and a smaller diameter at a lower end thereof, the housing having a plurality of slots extending downward from a rim at the upper end along a portion of the length of the housing to form a plurality of wings and capable of receiving folded-down portions of the bag upper end and hold the upper end open for filling flowable material into the bag while suspending the lower end of the bag adjacent the lower end of the housing.

10. The stand of claim 9 wherein the stand is capable of supporting at least two flexible bags simultaneously with at least one wing receiving folded-down portions of the upper end of one bag and at least one other wing receiving folded-down portions of the upper end of another bag to hold the upper bag ends open for filling flowable material into the at least two bags while suspending lower ends of the bags adjacent the lower end of the housing.

11. The stand of claim 9 wherein the slots have a curved lower end to permit the upper end of the bag to be removed from over the wings, twisted and re-inserted into a slot curved lower end to hold the upper end of the bag closed.

12. The stand of claim 9 wherein the slots have an enlarged lower end to permit the upper end of the bag to be removed from over the wings, twisted and re-inserted into a slot enlarged lower end to hold the upper end of the bag closed.

13. The stand of claim 9 wherein the housing comprises a plurality of frusto-conical sections, each section having a larger diameter at an upper end thereof and a smaller diameter at a lower end thereof, the diameter at a lower end of one section conforming to the diameter of the upper end of another section connected below the one section.

14. The stand of claim 13 wherein each housing section has a plurality of slots extending downward from a rim at the upper end along a portion of the length of the housing to form a plurality of said wings.

15. The stand of claim 13 wherein the housing sections are connectable by threads at upper and lower ends thereof.

16. The stand of claim 13 wherein the housing sections may be separated and nested within each other for transport or storage.

17. The stand of claim 9 acting as a hopper or funnel for flowable material wherein the housing has an opening at the lower end thereof, the housing being capable of receiving flowable material and passing the flowable material out through the lower end opening.

18. A portable stand for supporting and filling with flowable material one or more flexible bags having a wider upper end and a conical lower end, the lower end optionally connected to a nozzle for expressing the flowable material, the stand comprising two first and second half frame portions assembled in secured, adjoining relation to form a shaped upper rim and a shaped lower rim, with each half frame portion having first and second ribs extending between rim portions forming the shaped upper and lower rims when assembled, the lower rim supporting the stand from a surface and the upper rim supporting the bags near the upper ends thereof, the first ribs of the first and second half frame portions being connected along a central portion of their length, each of the first ribs having an offset portion between the central portion and the upper rim portions to form a circumferential gap between the respective upper rim portions capable of receiving folded-down portions of the bag upper end and hold the upper end open for filling flowable material into the bag while suspending the lower end of the bag adjacent the lower end of the stand.

19. The stand of claim 18 wherein the second ribs of the first and second half frame portions are also connected along a central portion of their length, each of the second ribs having an offset portion between the central portion and the upper rim portions to form a circumferential gap between the respective upper rim portions capable of receiving folded-down portions of the bag upper end and hold the upper end open for filling flowable material into the bag while suspending the lower end of the bag adjacent the lower end of the stand.

20. The stand of claim 18 acting as a stand for filling non-conical flexible bags, such as freezer bags.
